(19) United States
(12) Patent Application Publication
(10) Pub. No.: US 2026/0304265 A1
(43) Pub. Date: Oct. 1, 2026

(54) METHODS, ARCHITECTURES, APPARATUSES AND SYSTEMS FOR NON-RADIO MEASUREMENTS BASED LOWER LAYER MOBILITY

(71) Applicant: InterDigital Patent Holdings, Inc., Wilmington, DE (US)

(72) Inventors: Umer Salim, Vallauris (FR); Pascal Adjakple, Great Neck, NY (US); Ravikumar Pragada, Warrington, PA (US)

(21) Appl. No.: 19/480,500

(22) PCT Filed: Apr. 30, 2024
(86) PCT No.: PCT/US2024/027006

§ 371 Date: Oct. 31, 2025

Related U.S. Application Data
(60) Provisional application No. 63/463,160, filed on May 1, 2023.

(51) Int. Cl. H04W 36/08; H04W 36/00

(52) U.S. Cl. CPC H04W 36/08; H04W 36/0085

(57) ABSTRACT

In an embodiment, a method implemented in a wireless transmit/receive unit, comprises: transmitting, to the network, a first message comprising information on non-radio measurement capabilities; receiving, from the network, a second message comprising information for configuration to determine zone location of the WTRU; receiving, from the network, a third message comprising a plurality of mobility configurations and information indicating non-radio measurement quantities; determining one or more changes in non-radio measurement quantities; determining WTRU zone location based on non-radio measurements from the non-radio measurement quantities and based on configuration to determined zone location; transmitting, to the network, the determined zone location; receiving, from the network, a command message comprising information to perform a cell switch to a target cell associated with one configuration of the plurality of configurations; and performing the cell switch to the target cell based on the command message.

### CROSS-REFERENCE TO RELATED APPLICATIONS

The present application claims the benefit of US Provisional Patent Application No. 63/463,160 filed May 1, 2023, which is incorporated herein by reference.

### FIELD OF THE INVENTION

The present disclosure is generally directed to the fields of communications, software and encoding, including, for example, to methods, architectures, apparatuses, systems directed to wireless communication systems, and more particularly, to user equipment mobility within wireless networks.

### BACKGROUND

Mobility of a user equipment results in cell change for service continuity. Legacy mobility procedures primarily operate at radio resource control layer, also called layer 3 (L3). The network and the user equipment will exchange messages, measurements and configurations prior to cell change.

For networks employing high carrier frequencies, resulting in narrow beam transmissions requiring very dense deployments, traditional mobility framework based upon higher layer measurements, cell measurements, reporting, cell change/update decisions and executions involve very large overhead and incur latencies which far exceed the timescale of mobility events.

There is a need to improve mobility of user equipment within wireless network.

### SUMMARY

In an embodiment, a method implemented in a wireless transmit/receive unit may comprise a step of transmitting, to a network, a first message comprising first information on non-radio measurement capabilities. The method may further comprise a step of receiving, from the network, a second message comprising second information indicating a first configuration to determine zone location of the WTRU based on the non-radio measurement capabilities. The method may further comprise a step of receiving, from the network, a third message comprising third information indicating a plurality of mobility configurations, and indicating a second configuration of reporting trigger events based on non-radio measurement quantities. The method may further comprise a step of determining WTRU zone location based on the first configuration to determine zone location. On condition that a reporting trigger event of the configured reporting trigger events gets satisfied, the method may further comprise a step of transmitting, to the network, a fourth message indicating the determined zone location. The method may further comprise, in response to transmitting the fourth message, a step of receiving, from the network, a command message comprising information to perform a cell switch to a target cell associated with one mobility configuration of the plurality of mobility configurations; and a step of performing the cell switch to the target cell based on the command message.

In another embodiment, a method implemented in a wireless transmit/receive unit may comprise a step of transmitting, to the network, a first message comprising information on non-radio measurement capabilities. The method may further comprise a step of receiving, from the network, a second message comprising information on network coverage and deployment topologies. The method may further comprise a step of receiving, from the network, a third message comprising a plurality of mobility configurations and information indicating non-radio measurement quantities for network coverage and deployment topologies. The method may further comprise a step of determining one or more changes in non-radio measurement quantities. The method may further comprise a step of determining WTRU zone location based on non-radio measurements from non-radio measurement quantities and based on network coverage and deployment topologies. The method may further comprise a step of transmitting, to the network, the determined zone location. The method may further comprise a step of receiving, from the network, a command message comprising information to perform a cell switch to a target cell associated with one configuration of the plurality of configurations; and a step of performing the cell switch to the target cell based on the command message.

In another embodiment, a method implemented in a wireless transmit/receive unit may comprise a step of transmitting, to the network, a first message comprising information on non-radio measurement capabilities. The method may further comprise a step of receiving, from the network, a second message comprising information for configuration to determine zone information of the WTRU. The method may further comprise a step of receiving, from the network, a third message comprising a plurality of mobility configurations and a plurality of non-radio measurements configuration associated with a plurality of zone information. The method may further comprise a step of determining zone information based on the second message. The method may further comprise a step of determining one non-radio measurement of the plurality of non-radio measurements associated with the zone information; and a step of performing the determined non-radio measurement based on the determined zone information.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a sequence diagram illustrating an example of a handover procedure;

FIG. 3 is a sequence diagram illustrating an example of a conditional handover procedure;

FIG. 4A is a system diagram illustrating an example of single-downlink control information-based Multi-TRP transmission;

FIG. 4B is a system diagram illustrating an example of multi-downlink control information-based Multi-TRP transmission;

FIG. 5 is a flow chart illustrating an example of an update of coverage information and lower layer triggered mobility (LTM) configuration of a WTRU;

FIG. 6 is a flow chart illustrating an example of a LTM measurements framework based upon reporting configuration;

FIG. 7 is a flow chart illustrating an example of a LTM measurements framework based upon measurement identities;

FIG. 8 is a flow chart illustrating an example of a LTM measurements framework with combined reporting and quantity configuration;

FIG. 9 is a block diagram illustration an example of a LTM measurement model with L1/L2 filtering;

FIG. 10 is a block diagram illustrating an example of a LTM measurements model with L1 and L3 based events;

FIG. 11 is a block diagram illustrating an example of a LTM measurements model with measurements biasing;

FIG. 12 is a block diagram illustrating an example of a unified measurement model with separate parameter sets for L3 and LTM measurements;

FIG. 13 is a flow chart illustrating an example of a network controlled LTM procedure triggered by non-radio WTRU measurements; and

FIG. 14 is a flow chart illustrating an example of a method of activation of LTM configurations based upon WTRU reported zone Information.

FIG. 15 is a flow chart illustrating an example of a method, implemented in a wireless transmit/receive unit, WTRU, for performing cell switch based on WTRU zone location according to one embodiment;

FIG. 16 is a flow chart illustrating an example of a method, implemented in a WTRU, for performing cell switch based on WTRU zone location according to another embodiment; and

FIG. 17 is a flow chart illustrating an example of a method, implemented in a WTRU, for performing non-radio measurements based on WTRU zone information according to an embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

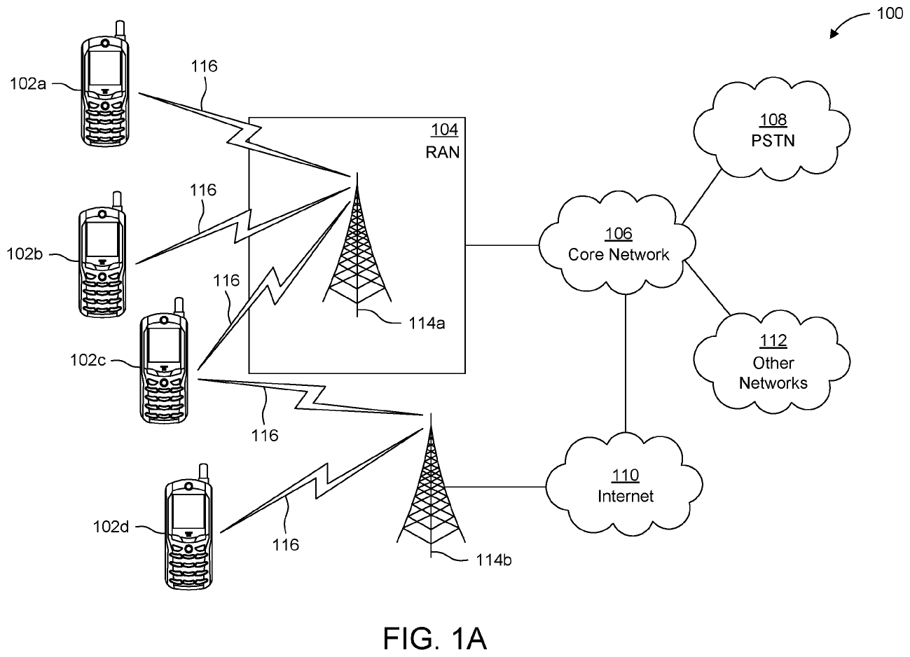

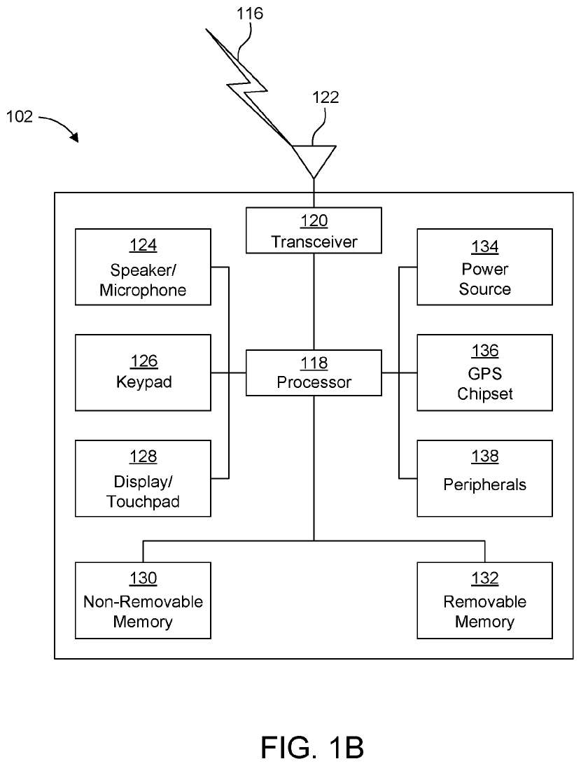

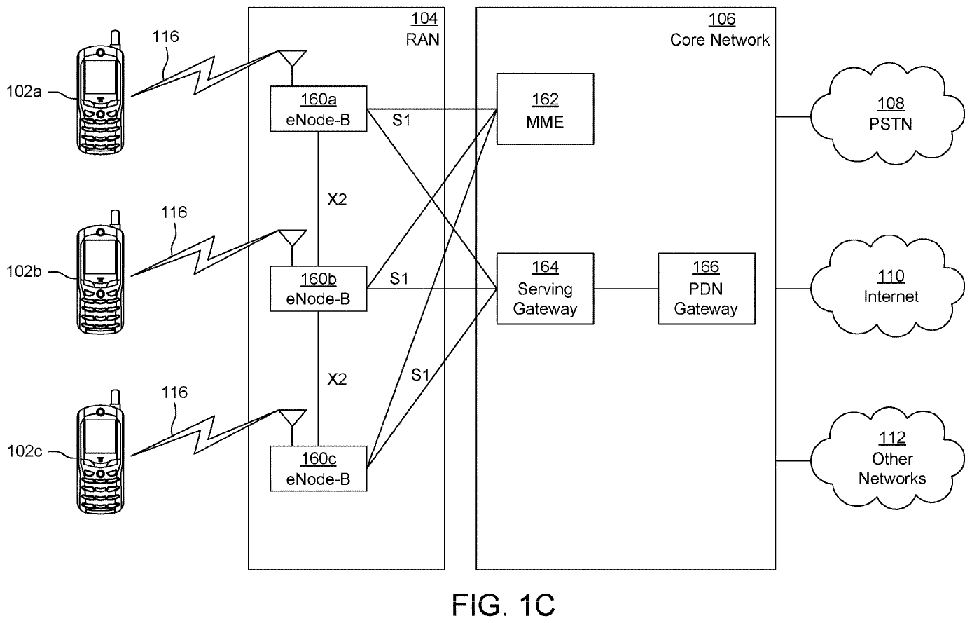

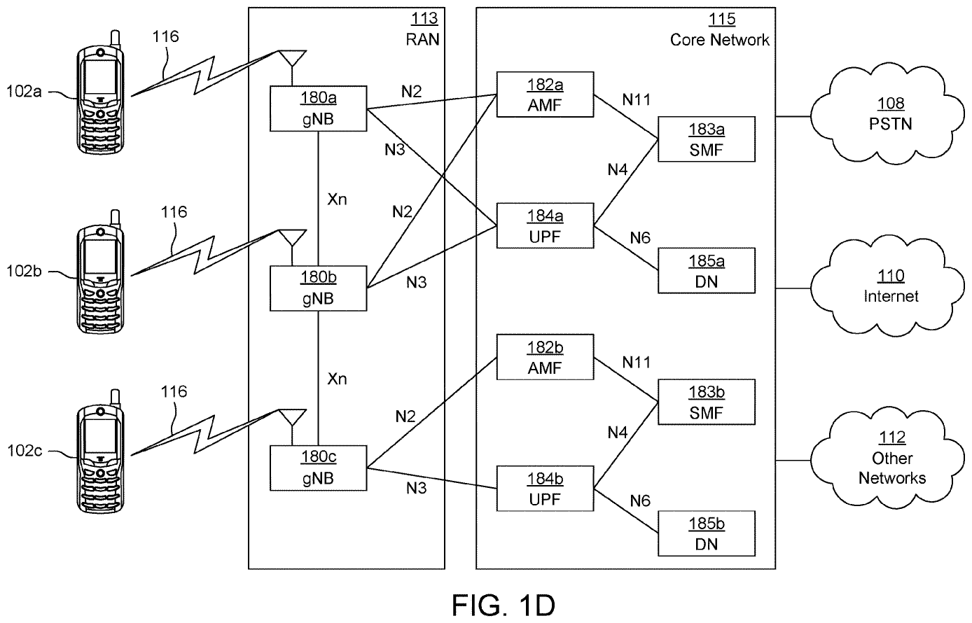

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an SI interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signalling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signalling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device (e.g., a network node) may be directly coupled to another device for purposes of testing and/or may performing testing using over-the-air wireless communications.

The one or more emulation devices may perform the one or more, including all, functions while not being implemented/deployed as part of a network node (e.g., wired and/or wireless communication network). For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

WTRU mobility may result in cell change for service continuity. Legacy mobility procedures primarily operate at radio resource control (RRC) layer, also called layer 3 (L3). The network and the WTRU will exchange messages, measurements and configurations prior to cell change. In the description below, protocol stacks as layer 1, layer 2 and layer 3 may be defined as follow: Layer-1 is the physical layer. Layer-2 may include MAC layer, radio link control (RLC) layer and Packet Data Convergence Protocol (PDCP). Layer-3 is the RRC layer.

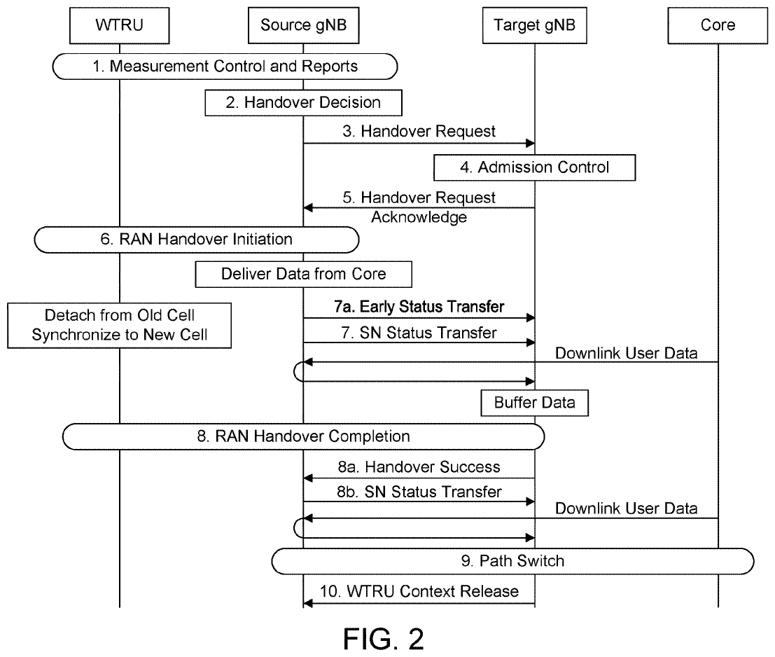

In an embodiment, L3 mobility procedure may be a gNB handover procedure, also call a legacy handover. In case a WTRU is in RRC connected mode, cell/gNB level mobility may require explicit RRC signaling to be triggered. A WTRU may report a cell quality measurement to its serving (source) cell when a neighboring cell quality is offset better for a preset duration of time-to-trigger (TTT). Different events called A1, A2, A3, A4, A5, etc. may be defined for WTRU measurement report triggering. The TTT and the cell specific offsets may be specified during the measurement configuration step. If a handover (HO) decision is made based on the measurement report, the source gNB may issue a handover request to a target gNB. If the WTRU is admitted by the target gNB, the target gNB may send a handover request acknowledgement to the source gNB, which contains an RRC message to be sent to the WTRU. Next, the source gNB may initiate handover and may send a RRC reconfiguration message to the WTRU. It can also include a set of dedicated random access channel (RACH) resources. Finally, the WTRU may synchronize to the target cell and may complete the RRC handover procedure. The overall HO procedure is illustrated in FIG. 2

Referring to FIG. 2, at step 1, a source gNB may configure WTRU measurement procedures and WTRU reports according to a measurement configuration. At step 2, the source gNB may decide to handover the WTRU, based on a measurement report and on radio resource management information. At step 3, the source gNB may issue a handover request message to the target gNB passing a transparent RRC container with necessary information to prepare the handover at the target side. At step 4, an admission control may be performed by the target gNB. At step 5, the target gNB may prepare the handover with layer 1 and/or layer 2 (L1/L2) and may send a handover request acknowledge to the source gNB, which may include a transparent container to be sent to the WTRU as an RRC message to perform the handover. The target gNB may also indicate if a Dual Active Protocol Stack (DAPS) handover is accepted. At step 6, The source gNB triggers the handover by sending an RRC Reconfiguration message to the WTRU, containing the information required to access the target cell.

At step 7a, for data radio bearers (DRBs) configured with DAPS, the source gNB may send a EARLY STATUS TRANSFER message.

At step 7, for data radio bearers (DRBs) not configured with DAPS, the source gNB may send a SN STATUS TRANSFER message to the target gNB to convey the uplink PDCP SN receiver status and the downlink PDCP SN transmitter status of DRBs for which PDCP status preservation applies.

At step 8, the WTRU may synchronise to the target cell and completes the RRC handover procedure by sending RRCReconfigurationComplete message to target gNB. In case of DAPS handover, the WTRU may not detach from the source cell upon receiving the RRCReconfiguration message.

At step 8a an at step 8b, in case of DAPS handover, the target gNB may send a HANDOVER SUCCESS message to the source gNB to inform that the WTRU has successfully accessed the target cell. In return, the source gNB may send the a STATUS TRANSFER message for DRBs configured with DAPS.

At step 9, the target gNB may sends a PATH SWITCH REQUEST message to the network (e.g., core network) to trigger the core network to switch a DL data path towards the target gNB and to establish an interface instance towards the target gNB. The core network may switch the DL data path towards the target gNB. The core network (e.g., UPF) may send one or more “end marker” packets on the old path to the source gNB per PDU session/tunnel and then can release any U-plane/TNL resources towards the source gNB. The core network (e.g., AMF) may confirm the PATH SWITCH REQUEST message with a PATH SWITCH REQUEST ACKNOWLEDGE message.

At step 10, upon reception of the PATH SWITCH REQUEST ACKNOWLEDGE message from the core network (e.g., AMF), the target gNB may send a WTRU CONTEXT RELEASE to inform the source gNB about the success of the handover.

The HO process may fail due to poor channel qualities of the target gNB, the source gNB or both. In a scenario with directional links, handover problems may be exacerbated because the link qualities of the target and source gNBs can deteriorate quickly due to mobile blockers or WTRU rotations. The blockage of target gNB during a handover procedure may result in a handover failure (HOF). When the WTRU receives RRC Reconfiguration message, a handover failure timer may be started. If the handover failure timer expires before the handover is completed, a HO failure (HOF) may be declared, and the WTRU may perform connection re-establishment. After a sudden WTRU rotation or a blockage, the source gNB may not be able to initiate a handover procedure in time based on the most recent measurement reports. Even the measurement reports from the WTRU may be lost due to poor link quality. Thus, without handover assistance from the source gNB, even when there are potential target gNBs with good channel qualities, the WTRU may need to either wait for the source gNB to recover from outage or declare a radio link failure (RLF).

As a potential solution to the target gNB being blocked, dual-active protocol stack (DAPS) handover was specified in 3GPP Rel. 16. In DAPS handover, the WTRU mays not release the source cell connection until random access to the target gNB is completed. If the target gNB link deteriorates before random access is completed, WTRU may fall back to the source gNB.

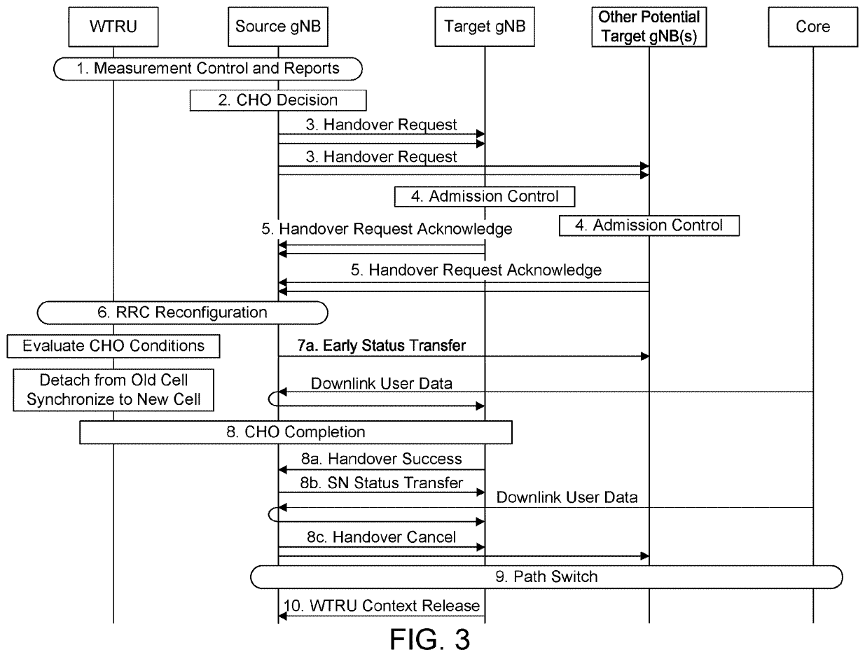

To address the blockage of the source gNB, conditional handover (CHO) was specified in 3GPP Rel. 16. In CHO, a WTRU may be configured to execute handover when one or more handover execution conditions are met. The source gNB can proactively configure the WTRU to evaluate CHO execution conditions defined for candidate gNBs. Once the conditions are met, e.g., when the target gNB is an offset better than the source gNB, the WTRU may initiate handover to a target gNB without the signaling from the source gNB. Thus, even when the source gNB is in outage state due to a sudden blockage or a rotation, the WTRU may still successfully complete a handover with the target gNB if a CHO execution condition is satisfied. The overall CHO procedure is illustrated in FIG. 3.

Referring to FIG. 3, at step 1, a source gNB may configure WTRU measurement procedures and WTRU reports according to a measurement configuration. At step 2, the source gNB may decide to use CHO. At step 3, the source gNB may request CHO for one or more candidate cells (e.g., target gNBs) belonging to one or more candidate/potential target gNBs. A CHO request message may be sent for each candidate cell. At step 4, an admission control may be performed by the one or more target gNBs. At step 5, the candidate target gNB(s) may send CHO response (HO REQUEST ACKNOWLEDGE) including configuration of CHO candidate cell(s) to the source gNB. The CHO response message may be sent for each candidate cell. At step 6, the source gNB may sends an RRCReconfiguration message to the WTRU, containing the configuration of CHO candidate target cell(s) (e.g., target gNB) and CHO execution condition(s). The WTRU may send an RRCReconfigurationComplete message to the source gNB. At step 7a, if early data forwarding is applied, the source gNB may send an EARLY STATUS TRANSFER message to the potential target gNBs.

At step 8, The WTRU may maintain connection with the source gNB after receiving CHO configuration and may start evaluating the CHO execution conditions for the candidate cell(s). If at least one CHO candidate cell satisfies the corresponding CHO execution condition, the WTRU may detach from the source gNB, may apply the stored corresponding configuration for that selected candidate cell (e.g., potential target gNB), may synchronise to that candidate cell and may completes the RRC handover procedure by sending RRCReconfigurationComplete message to the target gNB. The WTRU may release stored CHO configurations after successful completion of RRC handover procedure. At step 8a and step 8b, the target gNB may send a HANDOVER SUCCESS message to the source gNB to inform that the WTRU has successfully accessed the target cell. In return, the source gNB may send a SN STATUS TRANSFER messageto the target gNB. At step 8c, the source gNB may send a HANDOVER CANCEL message toward the other signalling connections or other candidate/potential target gNBs, if any, to cancel CHO for the WTRU.

At step 9, the target gNB may sends a PATH SWITCH REQUEST message to the network (e.g., core network) to trigger the core network to switch a DL data path towards the target gNB and to establish an interface instance towards the target gNB. The core network may switch the DL data path towards the target gNB. The core network (e.g., UPF) may send one or more “end marker” packets on the old path to the source gNB per PDU session/tunnel and then can release any U-plane/TNL resources towards the source gNB. The core network (e.g., AMF) may confirm the PATH SWITCH REQUEST message with a PATH SWITCH REQUEST ACKNOWLEDGE message.

At step 10, upon reception of the PATH SWITCH REQUEST ACKNOWLEDGE message from the core network (e.g., AMF), the target gNB may send a WTRU CONTEXT RELEASE to inform the source gNB about the success of the handover.

Although CHO is resilient to mobile blockers and can significantly reduce the number of RLFs originating from fast deteriorating links, its success may depend on the availability of candidate gNBs before the failure of the source link, the link quality of the target links, as well as the conditional thresholds for the target gNBs. Even if there are candidate gNBs, a WTRU may need to be able to maintain the link quality with the selected candidate gNB until the handover completion. Careful configuration of the conditional thresholds for the handover execution may be also needed. Higher threshold values may lead a WTRU failing to timely execute the handover to a target gNB resulting in a failed handover. On the other hand, lower threshold values may lead to a sub-optimal choice of a new serving gNB and potentially useless handovers in certain cases.

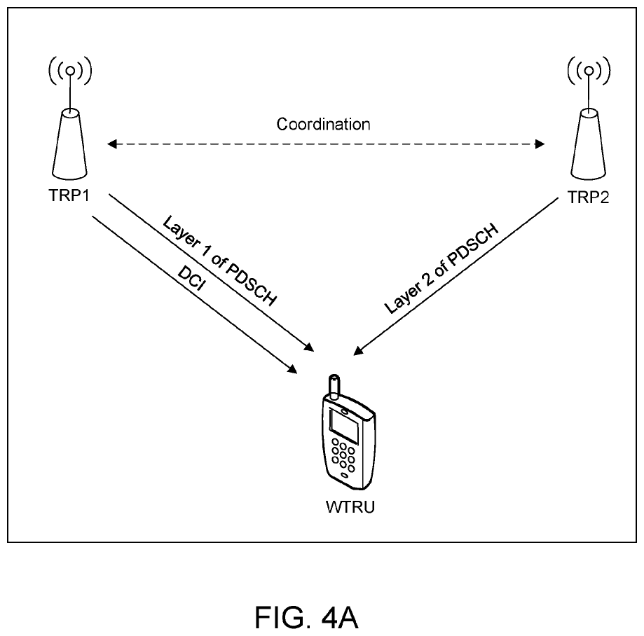

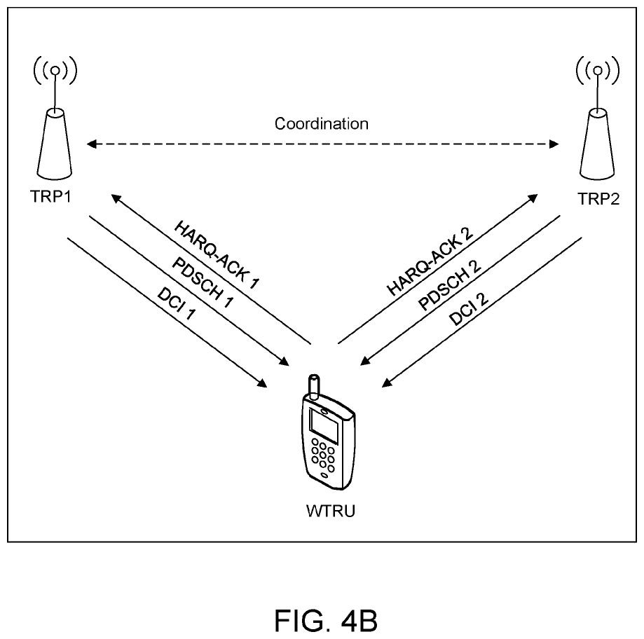

Multi-transmission reception points (TRP) transmission mechanisms may be limited to INTRA-CELL case and may be specified to support non-coherent joint transmission (NCJT), which can improve downlink data rate and spectral efficiency, especially for cell edge users. Considering various backhaul capabilities (e.g., ideal backhaul, non-ideal backhaul) in practical deployments, two different NCJT-based transmission schemes may be supported: single-downlink control information (DCI)-based and multi-DCI-based as shown in FIG. 4a and FIG. 4B.

Referring to FIG. 4A, single DCI based transmissions may be more suitable for ideal backhaul between the TRPs as a single DCI schedules the resources from two TRPs. To receive DL data from different TRPs (TRP1, TRP2), the WTRU may be provided with two Transmission Configuration Indication (TCI) states, and each TCI state may correspond to one TRP and provides the quasi co-location (QCL) information for the corresponding PDSCH layers. Different TCI code points may be activated by MAC and the scheduling DCI may indicate one of the activated TCI code points having 2 TCI states.

Referring to FIG. 4B, multi-DCI based schemes may support scenarios with non-ideal backhaul where each TRP (TRP1, TRP2) may use its own DCI (DCI1, DCI2) to schedule its resource. In the RRC configuration, two TRPs (TRP1, TRP2) are implicitly represented with two different control resource set (CORESET) groups, each of which is identified by the value of RRC parameter CORESETPoolIndex.

Multi-TRP operation may be extended to inter-cell case. This may be achieved by allowing a TCI state to be defined from a synchronization signal block (SSB) that is associated with a physical cell identity (PCI) different than the cell to which the WTRU is RRC connected, which enables inter-cell multi-TRP operation by proper configuration/activation of TCI states that can be associated with either of the PCIs.

For networks employing higher carrier frequencies, resulting in narrow beam transmissions requiring very dense deployments, traditional mobility framework based upon higher layer measurements, cell measurements, reporting, cell change/update decisions and executions may involve very large overhead and may incur latencies which far exceed the timescale of mobility events.

Layer 1 and/or layer 2 triggered mobility (LTM) may minimize the mobility interruptions. A significant reduction in mobility interruptions may be realized by triggering the mobility events based upon non-radio based measurements. The triggering of mobility events based upon non-radio measurements combined with the network knowledge of cells/beams deployment may lead to a more deterministic manner of mobility handling.

The following problems need to be solved to achieve deterministic L1L2 triggered mobility using non-radio measurements: How to enable L1L2 mobility features with a focus on measurements and event set over non-radio measurement quantities? And, what are the configurations, execution conditions, triggers, and step-by-step actions for such L1L2 triggered mobility procedures?

In various embodiment described below, non-radio measurements based solutions to minimize mobility interruption are detailed.

Evolution of wireless systems with new applications requiring low-latency, high-reliability and high-availability has resulted in greater focus and activity to the service continuity while being in mobility and to minimize the service interruptions due to mobility. To that end, 3GPP has defined and standardized a number of mechanisms where mobility interruptions are minimized through faster switching of beams, cells and network nodes.

Described below various embodiments may achieve lower layered triggered mobility principally triggered by measurements over non-radio measurement quantities in a bid to achieve almost deterministic mobility. The proposed approach of non-radio measurements based mobility hinges upon the (i) the knowledge of network deployment of its nodes/cells/beams and (ii) the capabilities of WTRUs to make non-radio measurements in different forms such as tracking their movements, determining updated geographic location/position and orientation in a very accurate manner, (iii) the network combining the deployment information with the WTRU reporting of non-radio measurements to determine the (e.g., suitable) target LTM candidate and move the WTRU from its serving cell to such determined LTM target.

This strategy may be applicable where the environment is controlled implying that the network knows what the surroundings to a moving device/WTRU are and thus the radio conditions are deterministic with respect to the reporting of the non-radio measurements related to the WTRU location/position and orientation. For this reason, the various below embodiments may be applicable to non-public networks and/or private networks. The below various embodiments may be also applicable in industrial/factory settings where the knowledge of the environment is heavily controlled and known to the operator deploying the network, which in many cases the industry owner or someone working on their behalf. Another scenario for controlled environments can be bit more futuristic that the operator has such precise information of the environment through other sources (topography, visual images, live cameras etc) that even in the public network settings, the network dynamics and changes in the environment are known.

In public cellular networks, the operators may be hesitant to share the deployment configuration fully with the devices as that may pose a certain level of risk to their installations. One important aspect related to controlled environments and factory settings such as warehouses etc. is the fact that the communicating devices (such as robots, industrial machines etc.) are also installed and operated by the same owner. This provides confidence that the network topology configuration will not be used for purposes other than the ones for which it is shared with the devices. To make broader use of the various proposed embodiments while keeping the precise information secure, the deployment topology is provided in a different form where the zones are provided with indication of cells/beams which are of interest in this zone.

In a different setting, LTM strategy can be helpful when the relevant devices have constrained measurement capabilities, either because of power constraints, hardware, antenna/panel implementation restrictions, and thus the network decisions are taken primarily based upon the non-radio measurement quantities.

In the below various embodiments, the proposed LTM strategy can be broadly split in two major phases. The first phase may be the non-radio measurements based LTM preparation phase. The second phase may be the execution phase.

The WTRU ability to fast detect its location/orientation and geographic coordinates in a very accurate manner can be used to choose the node/cell/beam to which the WTRU should be connected to. The network may share a finite piece of its deployment/coverage topology to the WTRUs which WTRUs use to report their precise instantaneous coverage coordinates to the network. The details on the coverage topology contents, configuration, maintenance, signaling mechanisms, and WTRU post-processing are provided below.

In various embodiments, LTM procedures may use non-radio measurements. Measurement framework over radio and non-radio measurements are also provide below. This framework can be used for measurements over 3GPP radio signals, non-3GPP radio signals, data from local sensors and other interfaces. To reduce latency and achieve a certain level of stability and accuracy in measurements, different measurements models may select measurement quantities from either L1, L3 or a combination of the former.

If LTM procedure is running based only upon radio measurements, due to noise and fading impacting the quality of radio signal estimations, there could be ping-pong effects where a WTRU may be switching back and forth among a group of cells. The use of non-radio measurements helps get rid of this problem.

In various embodiments, the LTM procedures may be network controlled. The network may issue explicitly a command for a WTRU to switch from its serving cell to the target cell. The network decisions may be the result of WTRU making measurements and reporting to the network.

Lower layer triggered mobility or L1L2 triggered mobility (LTM) are used herein as terminology to call out the procedures where the cell switching triggers, commands and confirmations are exchanged primarily on lower layers of WTRU and network, contrary to the legacy mobility procedures running over RRC or layer 3. These lower layers are PHY layer or MAC layer or a combination of both as will be detailed in the below embodiments.

The preparation phase for the non-radio measurements based LTM procedure basically may comprise any of the configuration of the deployment topology, LTM cell configurations, measurement configurations and WTRU capability transfer to the network to support the procedure.

About deployment and coverage zones, cellular networks may be planned networks with operators deploying the network nodes at (e.g., suitable) locations to provide sufficient coverage to their subscribers. Thus, the network operator may have (e.g., very precise) knowledge of its deployment of cells, and the beams within those cells in terms of coverage zone attributes such as the locations (e.g., reference location) of cells or transmission points (TRPs), potential spatial directions of transmission defined for example by azimuth, elevation angles and location coordinates of the TRPs, beam width information such as 3-dimentional (3D) beam width information, for example in horizontal and vertical directions, transmission range information, coverage shape information including for example location coordinates of points that constitute the coverage border of a beam, cell or TRP.

A deployment topology may comprise any of information about the location of TRPs and coverage/orientation of beams. In one embodiment, the location of TRPs can be represented in terms of 2D coordinates, with an example of 2D coordinates the latitude and longitude coordinates. The location can be represented in 3D coordinates with the addition of altitude or height to 2D coordinates. Both 2D or 3D representations can be in global or local coordinate systems.

The beams from a given TRP can be represented using azimuthal and elevation angles. Suitable references may be used like cardinal directions and zenith, or reference directions can be provided as part of the configuration. These angles may be provided with refinement or quantization to capture meaningfully the mobility procedures and signal strengths within or out of the coverage for a given beam. In addition to the angles, the beam widths in these directions can be additionally provided explicitly for the beams. Thus, having the knowledge of the TRP location parameters and the beam angles (plus widths), a WTRU can prepare a local topology where it can see the coverage of different beams from different TRPs. Additional attributes, like range/power can be added to cell/beam to refine further the deployment topology.

A coverage topology may provide the indication of geographic coverage from different TRPs for different beams. Through representations, it may provide the coverage boundary of different TRPs and different beams. The coverage topology may incorporate the nature of the terrain, topographic aspects, buildings, and other geographic parameters on the deployment topology to prepare zones and boundaries associated to the coverage of different beams from different TRPs.

The representation of the coverage topology can be in the form of (e.g., suitable) geometric shapes. To indicate the shapes delimiting the cells/beam level coverage, different reference shapes can be defined. The reference shapes can be in the form of circles, ovals, ellipses, ellipsoids with (e.g., suitable) parameterization. The coverage topology may be indicated using these shapes with (e.g., suitable) attributes. These attributes may provide links to the cell/beam identities to which a given shape/area is associated.

The terms “deployment topology” and “coverage topology” are interchangeable herein. If a distinction is required, it will be mentioned explicitly.

A coverage topology may be associated with an area denoted here coverage topology area. A coverage topology area may correspond to one or more cells, a RAN notification area (RNA), a tracking area (TA), a public land mobile network (PLMN), etc.

The coverage topology may be defined at different granularities. The granularity of the coverage topology may be part of the coverage topology configuration. In one embodiment, the coverage topology may be defined at cell level and the information of geographic coverage from different gNBs/TRPs may be indicated to WTRUs with (e.g., suitable) signaling. The cell level coverage can be useful for different hand-over and cell change procedures.

The coverage topology granularity may be reflected in the form of coverage zones. For cell level procedures, the coverage topology zones can have the cell level granularity. For beam level procedures where for example a WTRU may need to track, maintain, or switch beams, the coverage topology granularity may be defined at beam level, and the zones in such a coverage topology may be attributed to different beams.

The zones can be attributed to given beams from given TRPs. A further refined granularity can be achieved by defining and associating zones in different directions from each gNB or TRP. The zones in the coverage topology can be indicative of the geographic area which corresponds to a given set of reference signals. For beam level zones, in one design, each zone can indicate the coverage area for a synchronization signal and physical broadcast control channel block (SSB) beam. In another beam level zone design, each zone can indicate the coverage area for an SSB beam or a channel state information reference signal (CSI-RS) beam where SSB/CSI-RS beam is the coverage for the corresponding SSB/CSI-RS signals. The configuration may specify a one-to-one or one-to-many correspondence where one-to-many correspondence may exist when criteria for zone delimitation is not SSB but some other signal or GPS coordinates. The one-to-many correspondence many exist as well for overlaid networks where multiple cells/beams may be serving overlapping areas.

Each zone can be identified with an identity, which can be provided as part of the configuration. In another design, each zone identity can be a deterministic combination of identities of cells, TRP, SSB/CSI-RS beam that it is attributed to. The formulae to compute zone identity can be known to the network and the device a-priori, and they can use additional modulating parameters such as lengths, widths, number of SSB beams etc. which can be part of the system information or the configuration.

A different granularity for the zones can be at gNB, TRP or cell level. For cell level zones, the zone may indicate the area where this cell has sufficient coverage. The criterion for sufficient coverage may be specified in terms of existing cell selection, re-selection criterion, or new criterion associated to (e.g., suitable) reference signals may be specified. The cell level zone may group all the SSB/CSI-RS zones associated to a given cell and thus it represents the area where any of the SSB/CSI-RS signals for this cell may be received with a known/configured quality. In the same way, the zone representation may be extended to larger granularities for RNA, tracking area (TA) or PLMN based coverage zones. The cell level zone identity may be the cell identity or a deterministic modification of the cell identity by combining it with some other parameters. The same design may be used for zones to represent the coverage for RNA, TA, PLMN etc.

In an embodiment, the zones may be defined for each location using its longitude and latitude values. The zone length information can be provided as part of the configuration. The formulae to compute the zones can be pre-defined or could be signaled as part of the configuration from a pre-defined set. The design of the zone may facilitate the zone identities computation. For said zone design, the longitude and latitude values are the geodesic distances from the geographical coordinates (0,0), as in used in the NR sidelink framework. (e.g., Suitable) Parameters may be provided as part of the configuration to determine the zone modularity along the longitude and latitude directions. Only one single parameter may be used to determine the same modularity along longitude and latitude directions. This parameter can be a fixed value to ease the configuration. In this design, all the devices can compute their zones and the zones for any location against the longitude and latitude coordinates of that location.

An example of a deployment topology may comprise information about the location of TRPs and coverage/orientation of beams. In one example, the location of TRPs may be represented in terms of 2D coordinates, with an example of 2D coordinates the latitude and longitude coordinates. The location may also be represented in 3D coordinates with the addition of altitude or height to 2D coordinates. Both 2D or 3D representations can be in global or local coordinate systems. If the zones' configuration follows the sidelink design, the TRP locations may be provided against the zones instead of the longitude and latitude coordinates.

Beams from a given TRP may be represented using azimuthal and elevation angles. Suitable references may be used like cardinal directions and zenith, or reference directions can be provided as part of the configuration. These angles may be provided with refinement or quantization to capture meaningfully the mobility procedures and signal strengths within or out of the coverage for a given beam. In addition to the angles, the beam widths in these directions can be additionally provided explicitly for the beams.

The network may directly provide the configuration in the form of rich shapes which capture all the specific aspects of the local terrain, shadowing from buildings and other objects. One advantage of this scheme may be that the network not only precisely knows the deployment of its cells/TRPs and beams but in addition, it may have access to topographical data using a navigation system, cameras, and the ongoing measurements on cells/beams from the devices which let it know very precise coverage topology. One other advantage may be the use of all historic data in the form of network measurements, cells/beam transitions that can be used to update and refine such detailed coverage topologies. This approach may have a (e.g., large) signaling overhead. The amount of information that needs to be exchanged can be huge as the precise coverage for even a single beam may require a set of objects and their attributes communicated to a WTRU. The (e.g., large) signaling overhead may require several message exchanges at RRC level leading to increased configuration latency as well.

If the zones' configuration follows the sidelink design, the network may provide different cells and beams coverage indication which provides the association of these cells and beams to zones.

The topology configuration may be a hybrid of the two earlier approaches where some part may be indicated in the form of network deployment based configuration and some part may be indicated using the coverage topology based configuration.

In an embodiment, the initial configuration for the coverage topology may be communicated to a WTRU in the form of dedicated RRC signaling. A WTRU in RRC active state with mobility may be provided the initial coverage topology configuration. From WTRU perspective, the signaling may be dedicated but the network may provide the same information to a set of WTRUs. These WTRUs may be in the vicinity of each other and hence the same coverage topology may be relevant for them.

In an embodiment, the network (e.g., the base station) may broadcast coverage topology information. A new coverage topology system information block (SIB) may be specified. It is understood that in this case, the coverage topology information broadcasted by a cell or a TRP may be configured to reflect the local deployment environment of the cell or TRP broadcasting the coverage topology.

For many relevant cases, the initial configuration may provide a coarse coverage topology which may need to be refined to (e.g., suitable) granularities and coverage extension to be fully useful. To that end, the coverage topology may be refined suitably through dedicated signaling. The refinement may be network initiated when it is configuring certain applications/flows with QoS constraints necessitating proactive mobility. A WTRU may request the refinement of its coverage topology.

The network deployment topology may be shared with WTRUs following the configurations as proposed above, either by adding additional attributes to the cell configuration or by introducing new configurations having these geographic attributes and providing the links of these TRP/beam level configurations to the legacy cell configurations. To use in mobility events and effective selection of beams, cells, TRPs, a WTRU may need to have a detailed effective coverage topology that we may call on-the-ground coverage topology. There is still a question of how to make the deployment topology rich enough so that it captures all the topographical and shadowing aspects. This coverage topology should take into account not only the TRP locations and beam attributes, but it should incorporate the physical nature of the environment around including the specifics of the terrain, the buildings with all their physical attributes which may shadow, block or reflect the beams.

Below two embodiments are proposed which enable a WTRU acquiring/fabricating the on-the-ground coverage topology.

In a first embodiment, the network provided deployment configuration itself may be made very rich and refined and provided in the form of rich shapes which capture all the specific aspects of the local terrain, shadowing from buildings and other objects. To indicate the shapes delimiting the cells/beam level coverage, different reference shapes may be defined. The reference shapes may be in the form of circles, ovals, ellipses, ellipsoids with (e.g., suitable) parameterization. The network will then indicate these shapes with (e.g., suitable) attributes and providing their links to the cell/beam identity. One advantage of this scheme may be that the network may (e.g., precisely/accurately) know the deployment of its cells/TRPs and beams. It may have access to topographical data using a navigation system, cameras, and the ongoing measurements on cells/beams from the devices which let it know very precise coverage topology. One other advantage may be the use of all historic data in the form of network measurements, cells/beam transitions that can be used to update and refine such detailed coverage topologies. This approach may have a (e.g., large) signaling overhead. The amount of information that needs to be exchanged may be huge as the precise coverage for even a single beam may require a set of objects and their attributes communicated to a WTRU. The (e.g., large) signaling overhead may require several message exchanges at RRC level leading to increased configuration latency as well.

In a second embodiment, the network may provide to WTRUs a snapshot of its nodes deployment and limited information about the beams it transmits. Thus, this approach may be (e.g., mainly) used when the network is providing its deployment configuration. In this second embodiment, the network may provide information about any of the TRP locations, beam angles and beam specific parameters without modulating the coverage with the features of the local terrain. Due to little information compared to the first embodiment where the network provides the detailed coverage topology, the signaling overhead and latency performance of this approach may be much better than the former.

In this second embodiment, the devices may be supposed to get the deployment features/parameters for TRPs/beams and using the local knowledge through other technologies (local stored topography, positioning systems, cameras) prepare a refined coverage topology which adds the topographical aspects to the deployment configuration. After the local processing and fabrication, WTRUs may get the effective topology which may delimit different coverage zones associated to different beams and cells. This refined coverage topology may be then used in the beam and cell level mobility procedures at this WTRU. This local physical coverage topology may be refined with the mobility or additional information obtained from other sensors. As the devices may prepare this effective topology using the network provided deployment parameters combined with the information from local sensors, this may be supported by local sensors, additional storage and compute capability to prepare effective topologies by combing network deployment with the information from local sensors.

Hybrid solutions may be standardized to get the refined coverage topology at the devices. If there are devices which are not equipped with local sensors, or they don't have compute power to process and fabricate a topology themselves, the network may send the refined topology to such devices. Contrary to this, the devices having local sensors and compute/storage power may receive only limited deployment features from the network and prepare the effective topology locally. The hybrid solutions may also be used depending upon WTRU power consumption requirements, battery quality, remaining battery or as a function of active applications and their attributes.

Upon detection of change in coverage topology area, the WTRU may re-acquire a coverage topology for its current location. The re-acquisition may be in the form of dedicated RRC signaling. In another design, it could be through re-acquiring the coverage topology SIB. The WTRU detection of change in coverage topology area may consist of one or more of the followings: a change in serving cell or (re)selection to a cell that doesn't belong to the current coverage topology area; a (re)selection to an RNA that doesn't belong or doesn't correspond to the current coverage topology area; execution of an RNA update procedure, or transmission of an RNA update message to the network (e.g., base station); a (re)selection to a TA that doesn't belong, or topology doesn't correspond to the current coverage topology area; execution of a TA update procedure, or transmission of a TA update message to the network (core network); and a (re)selection to a PLMN that doesn't belong, or topology doesn't correspond to the current coverage topology area.

The WTRU may discard the coverage topology configuration information if it gets outdated. The outdated indication may be determined in case the WTRU changes it coverage area and is not able to acquire the updated coverage topology. In an embodiment, the configuration may comprise (e.g., explicit) timers which may result in WTRU releasing the configuration if expired. These timers may be refreshed if the WTRU is staying in the area associated to its current coverage topology. The coverage topology area may be defined in terms of RNA, TA, PLMN or another (e.g., suitable) criterion. The WTRU may receive from the network, an (e.g., explicit) indication to release its coverage topology configuration. The WTRU may release the coverage topology configuration if it goes out of RRC active state.

The below three embodiments relate to deployment topologies that may be provided to a WTRU and relate to cells/beam configurations and mobility configurations with the deployment configuration.

In a first embodiment, the deployment topology can be part of the cell/beam configuration. This cell/beam configuration may be part of the conditional (re-)configuration associated to the PsCell or SCell, and thus can be part of a conditional handover or conditional PSCell change/addition procedure. The deployment topology may be associated to any of the serving cell configurations and can be used for any of the beam management procedures, namely beam switching, beam failure recovery etc. New attributes may be added to the cell configuration which may define the TRPs where this cell is being transmitted, the locations of these TRPs in global or local coordinate systems, and the beam coverage attributes for the beams being transmitted through these TRPs. The configuration may provide the information on SSB beams or CSI-RS beams. The attributes for beams may be in the form of azimuthal and elevation angle with (e.g., suitable) reference directions. The reference directions may be taken from cardinal directions or may be indicated as part of the configuration itself. The range for the beams may be indicated as per beam attribute or a single value which may indicate the unobstructed range in view of the transmit power. The beam attributes may define the beam width in horizontal and vertical directions. A (e.g., simpler) deployment may specify one single beam width attribute for horizontal and one for vertical directions which are assumed to be the same for all the configured beams. For the deployments with varying beam width sizes, the network may provide one value for a TRP, and then delta values may be provided for each beam. As an alternative beam width may be provided as a part of the beam configuration without any TRP or cell level indication. In another alternative, the coverage for each beam may be specified as an ellipsoid with (e.g., suitable) parametrization.

In a second embodiment, the topology indication may be independent dedicated Configuration. More particularly, in the second embodiment, the topology may be provided as an individual configuration to WTRUs. The coverage topology configuration may not be part of the cell configuration or the conditional (re-)configuration. The coverage topology may depend upon the geographic deployment and coverage but its configuration and signaling may be provided by the network independent of the cell configuration or other conditional (re-)configurations.

The coverage topology configuration may be in the form of network nodes deployment and beam attributes, or it may be in the form of on the ground detailed coverage incorporating the topographic and terrain specific features. The coverage/deployment topology configuration may provide the linkage of indicated TRP locations and beam attributes to the cell identities and cell configurations.

In a third embodiment, the deployment/coverage topology indication may be transmitted by the network in the form of broadcast signaling. This indication may be broadcast by the network and the relevant devices may be pre-informed or may have prior knowledge of how to get and decode this indication. In one strategy, a control information to locate the topology related broadcast information can be broadcast, e.g., through a special paging or a special downlink control information informing all the devices about the broadcast-based topology information.

The topology indication may be treated as part of the system information. A new system information block (SIB) may be designed which can carry and convey deployment/coverage topology indication. The network may use periodic transmission of topology SIB to keep the WTRUs aware of the topology information. The WTRUs which may be starting the relevant services where outage needs to be minimized may send (e.g., explicit) request message to the network requesting the transmission of the topology SIB.

The network may provide several snapshots of deployment/coverage topology through RRC signaling, be it broadcast based or WTRU dedicated signaling. In these cases, the network may send a MAC Control Element (MAC-CE) which may indicate one of the deployment/coverage topology snapshots which may be considered as activated topology and may be used in LTM procedures. A customized MAC-CE may be designed for this purpose where the identity of the topology provides a pointer to one of the topologies configured through RRC signaling.

For more reactive situations, a physical (PHY) based signaling such as DCI may be used to activate one of the configured topologies.

D

Lower layer triggered mobility may be intended to change the cell, be it primary cell of the master cell group, primary cell of the secondary cell group, or any of the serving cell in master/secondary cell group. A target LTM configuration may be (e.g., basically) the cell configuration. In an embodiment, LTM configuration may be provided as part of the cell group configuration, through the “CellGroupConfig” information element. In another embodiment, LTM configuration may be provided through “SpCellConfig” or “SCellConfig”, though that imposes certain limitations in terms of LTM mobility scope.

One important point is related to WTRU monitoring and evaluating (e.g., certain) LTM measurement quantities and upon (e.g., certain) conditions getting fulfilled, events may be triggered. The details on LTM measurements and example events are provided below. These events may be linked to certain LTM configurations and triggering of such events then subsequently results in WTRU applying the linked LTM candidate configuration to achieve mobility with zero or minimal interruption and burdensome exchanges with the network. These procedures are explained below.

One of the initial objectives of LTM may be to exploit the knowledge and overlap of configurations for cells deployed through the same distributed unit (DU) or through different DUs. As with dense networks using access points serving smaller areas through narrow beams and with the roll out of LTM feature, a WTRU may potentially be configured with several LTM configurations in addition to higher layer configurations already supported. Supporting many LTM configurations has the advantage that a WTRU may be able to make faster LTM switch to one of the configured LTM candidates. On the downside, the network needs to provide all these configurations to the WTRU which may consume transmission resources. In addition, WTRU may need to keep all these configurations locally available to apply in case of LTM switching and may need to make measurements over the configured candidates and provide reporting to the network.

Following are various embodiments that may be used how the configurations may be provided from the network to the WTRU and how they may be maintained at the WTRU.

In a first embodiment, the network may provide individual configuration for each LTM candidate at the granularity of cell and beam. This has (e.g., extremely large) overhead in terms of transmission resources and WTRU maintaining individual configurations.

In a second embodiment, the network may provide individual configuration for each LTM candidate cell. This configuration may be linked to different beams of the candidate cell. These beams may be identified through SSB index, CSI-RS index or a TCI state representing QCL relation to a reference signal.

In a third embodiment, the cell configuration for each LTM candidate cell is provided as delta configuration with respect to a (e.g., suitable) reference configuration. Then, this cell configuration may be applied for configured beams/TCI-State of the candidate cell.

The (e.g., suitable) reference configuration against which delta configuration is provided, may be the primary serving cell. In the case of dual connectivity, the reference configuration may be the primary serving cell of the corresponding cell group.

In a various embodiment, a reference configuration may be explicitly provided to the WTRU. The network may determine a configuration which can best minimize the delta configurations size and the overhead in view of the serving DU, or the neighboring DUs.

In another embodiment, to minimize the signaling overhead, the network may indicate a (e.g., suitable) reference configuration as part of LTM delta candidate configuration. As an example, the network can provide LTM configuration for cell C1 as delta configuration. Within the delta configuration for C1, a pointer may indicate to the reference configuration which is to be used as the reference configuration for candidate C1. The network can select this reference configuration suitably, for example by providing the reference to one of the cell configurations which WTRU has been provided with and may be the cell configuration over the same DU. If the WTRU has not received any cell configuration on the same DU as candidate C1, the network may provide a pointer to a cell configuration on a different DU.

In an embodiment, the network may provide reference-DU-configurations associated to DUs for which it intends to provide candidates for LTM switching. The identities of DUs may be provided in a (e.g., suitable) format as part of these reference configurations. The delta configurations may be provided as delta configurations on top of the reference-DU-configuration. This may be achieved by indicating the reference-DU-configuration identity with each candidate delta configuration.

For embodiments with reference and delta configurations, whenever a WTRU performs LTM switching, it will apply the complete configuration which is determined jointly from reference configuration and the delta configuration for the LTM candidate. In case of conflict/overlap, WTRU may prioritize the configuration values/parameters provided as part of the delta configuration.

Examples of activation of LTM configurations for non-radio measurements based LTM are described below.

A WTRU may receive, from the network, several LTM configurations. Depending upon application requirements, WTRU mobility levels, WTRU capabilities to support simultaneous LTM configurations, WTRU subscription level and other network level consideration, the network may activate (e.g., only) a subset of the configured LTM configurations. In these cases, the network may send a MAC-CE which may activate the (e.g., suitable) LTM configurations. Two different MAC-CEs can be designed to accommodate a different number of LTM configurations which may need to be activated for an eventual LTM procedure. Customized MAC-CEs can be designed for this purpose where the identities of the LTM configurations provide pointers to the LTM configurations configured through RRC signaling.

For more reactive situations, a PHY based signaling such as DCI can be used to activate one of the configured LTM configurations.

One aspect of non-radio measurements based LTM, may be that the WTRUs may be performing very little radio measurements for the activated LTM configurations and in some cases the network can configure non-radio measurements such that there is zero measurement overhead from the WTRU perspective whether there is one or more LTM configurations in ACTIVATED state. For non-radio measurements based LTM procedure, all of the configured LTM configurations may be considered as activated LTM configurations for eventual switching upon receiving the LTM switching command from the network.

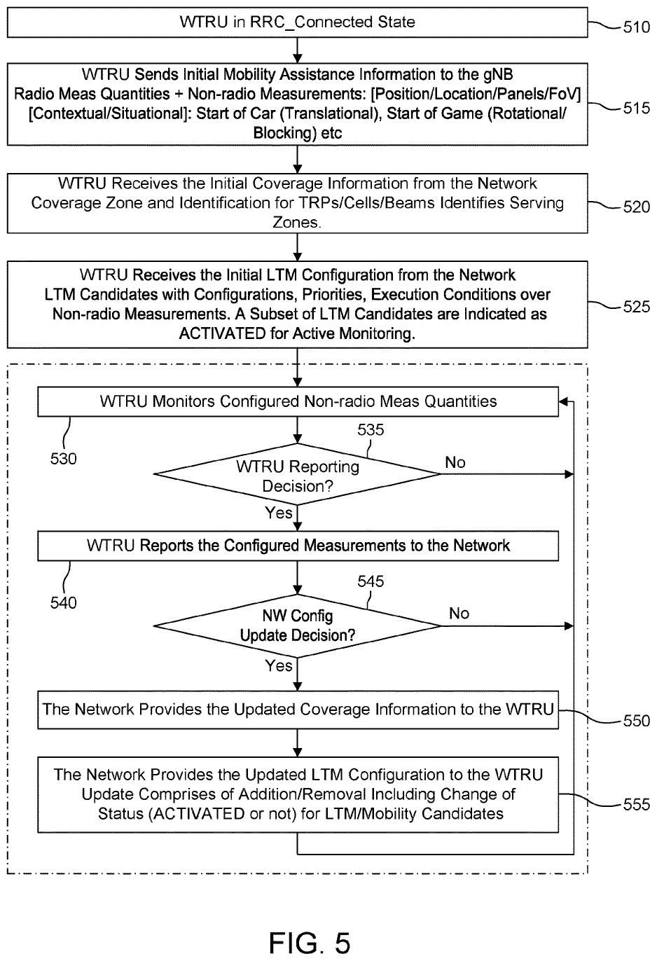

FIG. 5 depicts a flow chart illustrating an example of an update of coverage information and LTM configuration of a WTRU.

More particularly, and according to step 510, The network may provide an initial configuration of LTM candidate cells/beams to a WTRU in RRC_Connected state.

However, prior to receiving the initial configuration, at step 515, the WTRU may transmit an initial mobility assistance information to the network. Such initial mobility assistance information may comprise radio and non-radio measurement quantities. At step 520, the network may provide an initial coverage information to the WTRU which may be suitable according to the WTRU geographic location and the network deployment. At step 525, the network may also provide the initial mobility configuration, more specifically related to L1L2 triggered mobility (LTM). Initial LTM configuration may be comprised of (e.g., suitable) LTM configurations which may be triggered at L1L2. The choice of the LTM configuration candidates may depend upon WTRU capability for LTM mobility indicated to the network, WTRU mobility requirements for active services/applications (QoS/QoE), WTRU non-radio measurements such as geographic coordinates and orientation etc, network dynamics e.g., cell load, amount of active traffic with different QoS, subscription levels, differentiated services etc. The network may provide an initial configuration of LTM candidates to a given WTRU as a function of previously mentioned aspects.

Nevertheless, the initial configurations related to coverage information and LTM candidates may not be suitable anymore if the WTRU moves away from its previously reported location to a new location which may have different set of LTM candidate configurations.

Accordingly, referring to step 530, the WTRU may monitor, for instance, the configured non-radio measurements quantities and referring to step 535 the WTRU may decide to report its measurements, for instance considering whether values of said non-radio measurements quantities may have change over the time. In a case of deciding to report the measurements, referring to step 540, the WTRU may report to the network its measurements corresponding to the non-radio configured measurement quantities.

Thus, referring to step 545, if the reported measurements from the WTRU, for radio and non-radio measurement quantities, changes such that the previously configured LTM candidates are not suitable anymore, the network may update the configuration. The update process may comprise step 550 corresponding to an update of the network coverage information and step 555 corresponding to an update of LTM candidate configurations. The update may be incremental addition/removal of previously provided configurations. In some cases, the network may decide to provide the new configuration.

Although not shown in FIG. 5, the network may decide to update the configurations without explicit reports from the WTRU. One scenario can be where the network can estimate change of WTRU location/position through uplink signals. These uplink signals may be a WTRU uplink transmissions like PUSCH, physical uplink control channel (PUCCH) or some reference signals, e.g., sounding reference signals etc.

In another complementary embodiment, the network may decide to update the LTM configurations independent of WTRU reports. This update may be made without any report from the WTRU, or if there is a WTRU report indicating no change in the WTRU location/position etc. The network update may be triggered if there is a change in network dynamics in terms of active traffic and active devices. This may lead to a situation where some of the previously configured LTM candidates may not have resources to support an incoming WTRU through LTM procedure, and thus, the network may remove some of the previously configured LTM candidates and may provide the configuration of additional LTM candidates to the WTRU.

A key part of the various embodiments presented herein are the radio measurements, non-radio measurements and their combinations which may be used in lower layered mobility procedures. The mobility procedures of interest are the ones which are used for L1L2 triggered mobility (LTM). The measurement framework, configurations, quantities and reporting mechanisms proposed here may be used to provide measurement reports to the network and then network may use these potentially combined with other network/device information to proceed with network controlled and network triggered mobility procedures. In these procedures, the network may send a command to a target WTRU to make LTM switching to a given target cell/beam where the target cell/beam may be being broadcasted by the network from the same DU (intra-DU scenarios) or from a different DU (inter-DU scenarios) compared to the current serving cell/beam. Going beyond the network commanded LTM switching of cell/beam, the LTM measurement framework may enable configuration of LTM measurements, triggers and execution conditions which can serve to trigger WTRU managed LTM mobility to a target cell/beam. These cells/beams may be pre-configured by the network along with the execution conditions over (e.g., suitable) measurement quantities as proposed in this framework.

One aspect of LTM relevant measurements may be that these are primarily lower layer measurements where the processing, necessary filtering (if configured) and reporting happen at lower layers. The lower layer here includes layer 1 and layer 2. The primary role of Layer 3 (RRC layer of radio protocol stack) may provide the configurations of lower layers e.g., PHY layer and MAC layer, and the lower layers may make and may process measurements according to the configuration received through RRC. Some procedures may have some involvement from Layer 3 (RRC Layer of protocol stack) but whenever that is the case, it is mentioned explicitly.

The devices may be equipped with interfaces from non-3GPP RATs, local sensors, or maybe getting the environmental information and quantities from certain accumulation points. Usage of these quantities and their integration with the measurements over 3GPP standardized RATs may need a harmonized framework where WTRUs can use the data from non-3GPP RATs alone or in combination with the data/measurements over 3GPP RATs. The following sub-sections aim to provide a framework through which measurements or data quantities from non-3GPP RATs/sensors can be used for beam change and cell change procedures.

Although the measurement framework over 3GPP radio signals, non-3GPP radio signals and local sensors are discussed primarily in the context of lower layer mobility, it may be applicable to a wide variety of procedures/scenarios. The measurements and events may be used to adapt certain aspects of lower layer procedures, e.g., channel state information feedback. The measurements may be employed to start monitoring certain frequencies, cells, TRPs or beams at the trigger of certain of these events. The applicability may be also straightforward to higher layer procedures like classic handover, conditional handover, conditional PSCell change/addition etc.

A WTRU may provide an indication of its capability to make PHY layer measurements on radio signals and non-radio signals/sources. This capability may be initiated by the WTRU itself while attaching to the network or going in RRC state etc. The network may also request (e.g., explicitly) WTRU capability to make PHY layer LTM measurements and the WTRU may respond with its capability indication.

Several relevant PHY layer measurements for LTM procedures may be the quantities computed over reference signals. The most important are the (secondary) synchronization sequence (SS), channel state information reference signal (CSI-RS), positioning reference signals (PRS) and sounding reference signals (SRS). The definitions for the resource and the reference antenna connector can be similar to what is defined in 3GPP 38.215, for the computation of reference signal received power (RSRP), reference signal received quality (RSRQ), signal-to-noise and interference ratio (SINR) and Received Signal Strength Indicator (RSSI) etc.

About measurements on 3GPP radio quantities: Following are the quantities that a WTRU may measure on the PHY layer and can indicate its capability on these quantities, the number of measurements on intra-and inter frequencies, the number of frequencies/bands it can support for simultaneous measurements etc. These quantities may be (e.g., primarily) estimated over SSB, CSI-RS, PRS and SRS. The quantities may be any of: SS reference signal received power (SS-RSRP), CSI reference signal received power (CSI-RSRP), SS reference signal received quality (SS-RSRQ), CSI reference signal received quality (CSI-RSRQ), SS signal-to-noise and interference ratio (SS-SINR), CSI signal-to-noise and interference ratio (CSI-SINR), SRS reference signal received power (SRS-RSRP), received signal strength indicator (RSSI), DL PRS reference signal received power (DL PRS-RSRP), DL reference signal time difference (DL RSTD), the WTRU Rx-Tx time difference and SS reference signal antenna relative phase (SS-RSARP) About measurements on non-3GPP radio quantities: The WTRU may provide an indication of its capability to measure and report some non-3GPP signal quantities through other available receivers on the device. This may include, for example, GNSS, WLAN and Bluetooth relevant measurements. More particularly, this may include any of: GNSS code Measurements: the GNSS code phase (integer and fractional parts) of the spreading code of the GNSS satellite signal as provided by configuration or having a reference power; GNSS carrier phase Measurements: the number of carrier-phase cycles (integer and fractional parts) of the GNSS satellite signal as provided by configuration or having a reference power; WLAN RSSI: the IEEE 802.11 WLAN RSSI; Bluetooth Signal Power and Source ID Measurements; RF Pattern Identification and Matching based Measurements; Terrestrial Beacon Systems.

About non-radio measurements available from local sensors: In addition to the above-mentioned measurements, a WTRU may have local sensors which may provide additional measurements. Some examples are motion sensors (e.g., accelerometers, gyroscopes), environmental sensors (e.g., barometer), position sensors (e.g., magnetometers, orientation sensors) and velocity measurement sensors. These sensors may provide any of the following measurements: linear acceleration or change of linear acceleration, velocity or change of velocity, orientation or change of orientation, angular velocity or change of angular velocity, atmospheric pressure or change of atmospheric pressure, and magnetic field or change of magnetic field Some of these quantities may in addition be obtained through some non-3GPP interfaces. The WTRU capability indication may provide the sensors, the measurements available through those sensors and potentially the accuracy indication for those measurements.

About combination of radio and non-radio measurements. Another class of measurements may be defined which may be obtained by combining radio and non-radio measurements. One example may be the WTRU orientation with respect to a reference TRP. The WTRU self-orientation may be defined in a suitable manner e.g., the principal angle of its primary antenna (or antenna array) and can be obtained from local sensors. This could be known at the network or can be conveyed as part of capability exchange information. The WTRU orientation with respect to a reference TRP may be defined as the angle at the WTRU between its self-orientation and the line joining WTRU to the reference TRP. This determination may use a variety of sources and methods. In one method, the WTRU may use GPS signals processed at WTRU local sensor (hardware/firmware/software) combined with TRP location provided by the network over 3GPP radio signals. In another approach, the WTRU may process the TRP transmitted 3GPP radio signals and by local estimates made over these signals (such as angle of arrival etc.) to determine the angle of the reference TRP from the principal or broadside angle of its antenna array. This determination may make use of the local sensors such as magnetometer and other orientation sensors in addition to the processing performed over the 3GPP radio signals. This information may be used at the WTRU along with its self-orientation information to estimate the WTRU orientation with respect to the reference TRP. This class of measurements may be kept as a sub-group of non-radio measurements.

For multi-panel WTRUs, a notion of reference panel can be introduced at the WTRU side. This reference panel may be the one which has larger number of antenna elements, or better sensitivity, or primary antenna panel by implementation or better connection to WTRU Tx/Rx chains. For such WTRUs, this information may be shared with the network when the WTRUs provide the information about their antenna panels implementation.

For multi-TRP transmission scenarios, a notion of a reference TRP may be introduced for orientation determination purpose. The reference TRP can be the one transmitting DCI for single DCI based multi-TRP transmissions. For multi-DCI based multi-TRP, the reference TRP can be the one identified through lower CORESETPoolndex. In another design, the network may indicate explicitly the reference TRP. For WTRU based selection, the WTRU may determine the TRP that it receives through its reference antenna panel in case of multi-panel WTRU. In yet another design, the reference TRP selection can be left to WTRU and WTRU may provide the indication of reference TRP to the network through (e.g., suitable) signaling. For measurement configurations which are part of 3GPP Positioning and location services, RRC may request the location management function (LMF) to get positioning service for a target WTRU. The WTRU may be configured with reference signals and methods for positioning purposes, the results of which may be used in LTM based procedures. In another compatible design, the RRC layer may be permitted to request the target WTRU to launch the location services with the LMF and then LMF may provide the information related to positioning signals and procedures to RRC.

LTM measurements may be defined for each cell group. Thus, in case of dual connectivity, there can be one configuration for master cell group (MCG) and another configuration for secondary cell group (SCG).

LTM measurement configuration may be provided as part of the cell group configuration. This may be achieved by defining a new structure of “LTM_meas_config” within the “CellGroupConfig”. Providing the configuration of LTM measurements within the cell group (CG) configuration has the advantage that the configuration does not need to be provided with each cell change.

The LTM measurement configuration may be provided through RRC_Reconfiguration signaling. This may allow associating one configuration to MCG and another configuration to SCG. The additional benefit can be though that the configuration can be maintained even if the cell group configuration gets updated.

The LTM measurement configuration can be embedded inside (e.g., part of) a serving cell configuration. The serving cell configuration may provide the configuration for LTM measurements. This can be achieved by defining a new structure of “LTM_meas_config” within the “ServingCellConfig”. This may have the benefit that each cell may be configured with relevant LTM measurements. The drawback can be that the serving cell configuration gets bigger and serving cell updates requiring configuration updates may result in higher overhead.

LTM measurement configuration may include the configuration of LTM measurement resources and LTM reporting configuration. In addition, the configuration can comprise of the quantity configuration. The quantity configuration may provide the lower layer filtering, processing or other measurement criteria applied to the LTM measurements prior to reporting according to the reporting configuration.

The LTM measurement configuration may provide a variety of LTM measurement resources and LTM measurement reporting configurations. This may seem to have (e.g., very high) overhead for WTRU in terms of making measurements, processing, and reporting them to the network. In an embodiment, the WTRU may (e.g., only) make measurements for the LTM candidates which have been ACTIVATED. The activation may be through explicit network configuration, conditional upon radio or non-radio conditions, or through some timer expiry.

A set of measurement resources may be related to radio measurement resources which may be transmitted from a 3GPP RAT, e.g., NG-RAN, EUTRAN, UTRAN, GPRS, GSM etc. These sources may be configured with (e.g., suitable) parametrization. These sources could be one or more of SSB, CSI-RS, PRS, SRS or other reference signals which may be designed for measurement purposes. In addition to resource identification, resource mapping in terms of time and frequency, sub-carrier spacing (SCS), power control relevant parameters, periodicities for periodic resources, cell identities associated to measurement resources, QCL information for measurement resource may be provided.

In addition to the above parameters, certain new parameters may be added to the measurement resources which may help LTM procedures. These may include DU identity or a DU identifier, CU identity or a CU identifier, TRP identity or identifier etc. These may be of interest in certain cases where some aspects of LTM procedures need such information to be known at the WTRU, based upon which WTRU is expected to take certain actions.

Reporting configuration may provide the reporting attributes in terms of periodic, semi-persistent and aperiodic nature of the configured measurement reporting.

Reporting configuration may provide the resources to provide the report to the network. LTM reporting resources include PUCCH resources, PUSCH resources, or SR sent to the network when reporting conditions or trigger conditions are fulfilled. This may reduce the latency as reporting can be configured to be made over PHY layer or MAC layer in the form of a MAC CE which can be custom designed to convey the report of the configured quantities.

For some scenarios and procedures, where latency may not be an issue or the report size can be large, reporting can be RRC based.

Reporting configuration may provide the LTM triggers and execution conditions on the measurement quantities which are associated to a given reporting configuration.

Reporting configuration may provide sub-selection of measurement resources according to (e.g., suitable) criterion. In one non-limited example, the reporting configuration may indicate the reporting of the N quantities which are measured strongest/largest in the configured measurement period. In another compatible design, the reporting configuration may provide the reporting of N largest quantities if they are larger than a configured threshold. The value of N may be configurable. In some cases, N may take the value of 1, 2, 3 or more. When N is configured as 1, only the strongest measurement is reported among the measurements made on configured resources.

LTM measurement framework may provide the measurement quantities for the reporting purpose. The configuration for measurement quantities may provide the additional processing and filtering that needs to be applied to the raw measurements prior to reporting. The processing may include thresholding, quantization in particular formats, mapping to certain formats and bit ranges etc. The filtering coefficients may be specified to achieve a certain level of noise or channel variation filtered out. One non-limited example objective of LTM is to enable seamless mobility within shorter intervals of time, and thus, the filtering option can be enabled or disabled by configuration. In another implementation, the filtering coefficients may have a value such that they enable raw measurement reporting.

The configuration may provide the 3GPP based radio measurement quantities including SSB-index-RSRP, SSB-index-RSRQ, SSB-index-SINR, CRI-RSRP, CRI-RSRQ, CRI-CQI, CRI-SINR, PRS/SRS relevant quantities described earlier.

In addition to 3GPP based radio quantities, the configuration may provide the quantities for reporting and relevant post-processing/filtering for non-3GPP based radio signals and the quantities becoming available from local sensors and potentially other interfaces.

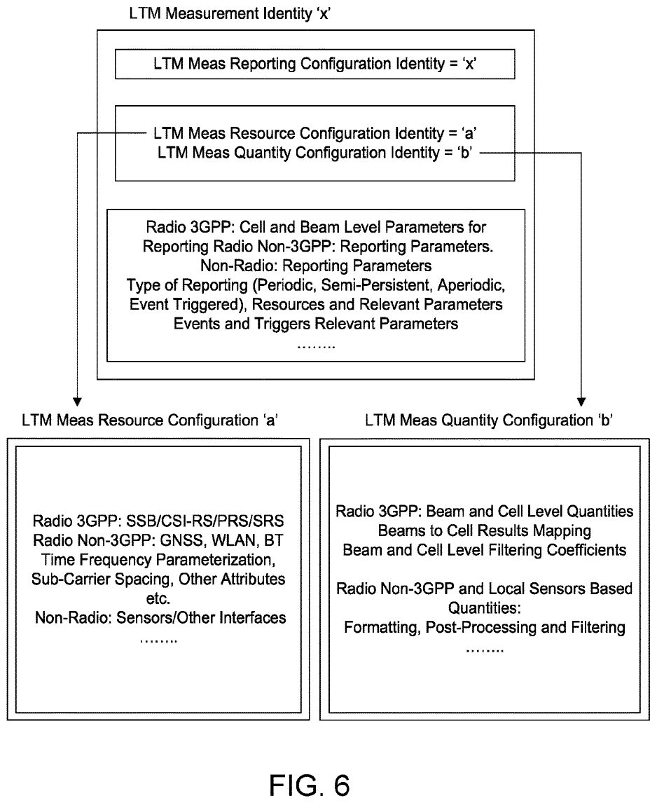

Referring to FIG. 6, an example of a LTM measurements framework based upon reporting configuration is shown. Referring to FIG. 6, in an embodiment, the LTM measurements may use the identity of LTM reporting configuration (LTM Meas Reporting Configuration Identity=‘x’ in FIG. 6) as the LTM measurement identity. Then reporting configuration provides pointers to the LTM measurement resource configurations (LTM Meas Resource Configuration Identity=‘a’ in FIG. 6) and LTM quantity configuration (LTM Meas Quantity Configuration Identity=‘b’ in FIG. 6. In this design, LTM measurements may be enabled, disabled, activated, de-activated or triggered through DCI using the identify of LTM reporting configuration.

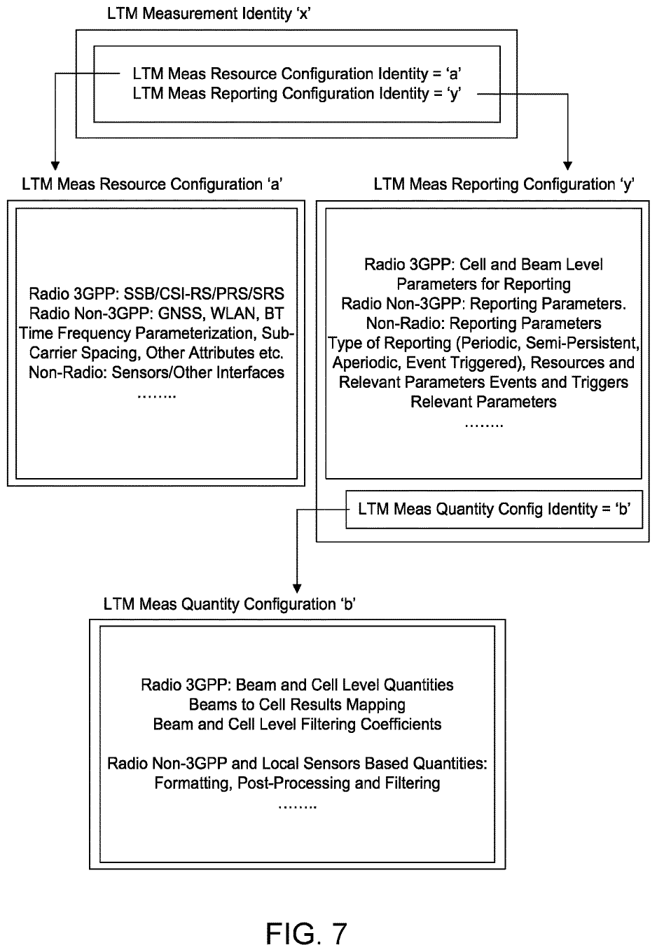

Referring to FIG. 7, an example of a LTM measurements framework based upon measurement identities is shown. Referring to FIG. 7, in another embodiment, there could be separate configuration for LTM measurement resources and LTM reporting. There is a separate LTM measurement identity (LTM Measurement Identity ‘x’ in FIG. 7) which may provide two pointers. One pointer may be to a set(s) of LTM measurement resource identity (LTM Meas Resource Configuration Identity=‘a’ in FIG. 7), and another pointer may be to an LTM reporting configuration (LTM Meas Reporting Configuration Identity=‘y’ in FIG. 7). In this design, a reporting configuration identity (object) may be not unique as LTM measurement identity may link a given reporting configuration to different sets of measurement resources to generate multiple LTM measurements. LTM measurement reporting configuration may provide another pointer to a (e.g., suitable) LTM measurement quantity configuration (LTM Meas Quantity Config Identity =‘b’ in FIG. 7). In a slight variation, the parameters of the quantity configuration may be (e.g., directly) specified within the reporting configuration.

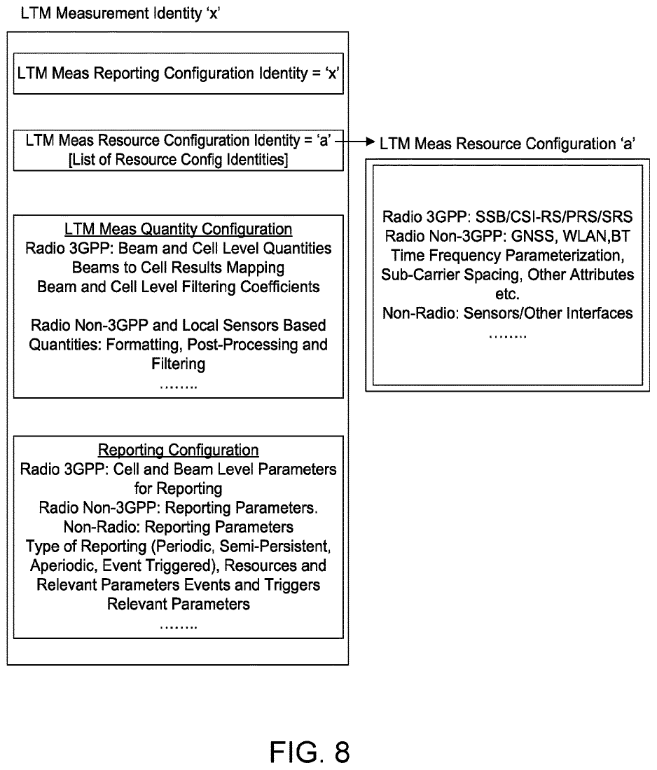

Referring to FIG. 8, an example of a LTM measurements framework with combined reporting and quantity configuration is shown. Referring to FIG. 8, in an embodiment, the LTM measurements may use the identity of LTM reporting configuration as the LTM measurement identity (LTM Measurement Identity=‘x’ in FIG. 8). The reporting configuration may provide all the necessary parameters related to reporting, quantity configuration and providing a list or a set of pointers to LTM measurement resource configuration identities (LTM Meas Resource Configuration Identity=‘a’ in FIG. 8).

LMT measurements associated to LTM candidate configurations may be associated to non-radio quantities and event.

In an embodiment, LTM measurements configuration may provide the activation condition over (e.g., suitable) non-radio quantities. These non-radio quantities may be specified as conditional events with suitable definitions of thresholds and offsets required to determine these conditions. In an embodiment, the activation of an LTM measurement configuration may be conditioned upon the event when the WTRU enters a specific zone.

In an embodiment, LTM measurements configuration activation may be conditioned upon the event when a WTRU device reaches close to a network deployed transmission point, and its orientation is aligned to that point as well. Such activation condition may be achieved by evaluating the event.

In an embodiment, de-activation conditions may be specified (e.g., explicitly) as part of LTM measurements configuration. In an embodiment, when activation conditions are not fulfilled, the WTRU may de-activate the corresponding measurement configuration. As a non-limited example, if the activation condition is conditioned on the WTRU entering a specific zone, if the WTRU exits the activation zone, the WTRU may be configured to treat that as de-activation condition and will stop making the measurements for this configuration.

The activation and/or de-activation conditions for LTM measurement configurations may be specified as part of reporting configuration.

In an embodiment, the activation conditions may be specified as part of the measurement identity.

In an embodiment, the activation conditions may be specified as part of the resource identity.

LTM measurements framework may be enhanced to report measurements made over non-3GPP radio signals and non-radio measurement quantities. Non-radio quantities may be the measurements available through local sensors and other interfaces.

The non-3GPP based radio measurements may have measurement resources defined for positioning and non-terrestrial network (NTN) ephemeris data. They may include the measurements from GNSS, WLAN, Bluetooth, or signals from other radio technologies that WTRU may be capable of measuring and reporting.

The LTM measurement framework may be enhanced such that a reporting identity may provide a reporting configuration for non-radio measurements. The reporting configuration may provide a combination of radio measurement resources (by indicating their identities) and non-radio measurement quantities through (e.g., suitable) parameterization. The configuration may comprise of non-radio quantities only and in that case the LTM report will comprise of non-radio measurements only. For non-radio-measurements, the reporting configuration may provide the information about the quantities with the events that need to be evaluated, reported, and used for decision making to perform the LTM switching or broadly used. These measurements may also indicate the type of filtering to be applied to these non-radio-measurement quantities through (e.g., suitable) parameters of quantity configurations. The filtering operation may be specified using the existing filtering mechanisms/coefficients for radio measurements, or new filtering procedures/coefficients may be provided to non-radio measurements.

About measurements available from local sensors: In addition to the above-mentioned measurements, a WTRU may have local sensors which may provide additional measurements. Some examples are gyroscopes, accelerometers, barometric sensors, velocity measurement sensors which may provide measurements such as velocity, acceleration, orientation, atmospheric pressure etc., which can be further processed to compute more elaborate quantities. Some of these quantities may in addition be obtained through some non-3GPP interfaces.

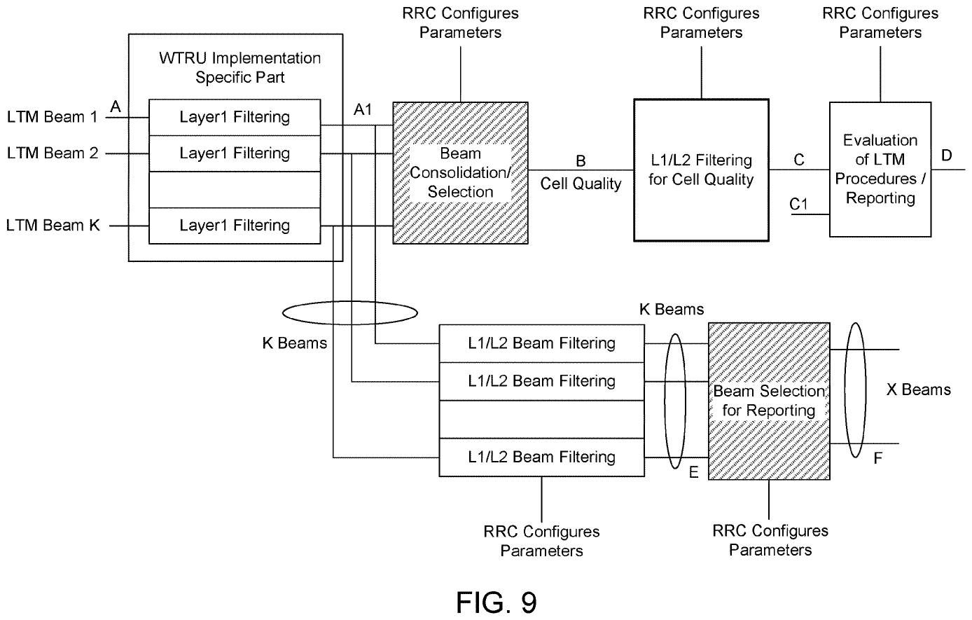

Referring to FIG. 9, for LTM measurements, a non-limited example of a model for the measurements, processing and filtering is shown. There could be L1 filtering left to WTRU implementation with performance requirements specified. Beam consolidation to cells and filtering procedures may specified by RRC layer. The L1/L2 filtered values may be used to evaluate the trigger conditions for LTM procedures or for reporting purposes.

Referring to FIG. 9, point ‘A’ corresponds to measurements (beam specific samples) internal to the physical layer. ‘Layer 1 filtering’ blocks in the WTRU implementation specific part correspond to an internal layer 1 filtering of the inputs measured at point ‘A’. Exact filtering is implementation dependent. How the measurements are actually executed in the physical layer by an implementation (inputs A and Layer 1 filtering) is not constrained by the standard.

Point ‘A1’ corresponds to measurements (e.g., beam specific measurements) reported by layer 1 to layer 3 after layer 1 filtering. Beam Consolidation/Selection block corresponds to beam specific measurements consolidation to determine cell quality. The behaviour of the Beam consolidation/selection is standardised, and the configuration of this module is provided by RRC signalling. Reporting period at point ‘B’ equals one measurement period at point ‘A1’. Point ‘B’ corresponds to a measurement (e.g., cell quality) determined from beam-specific measurements reported to layer 3 after beam consolidation/selection.

The L1/L2 filtering for cell quality block corresponds to a filtering performed on the measurements provided at point ‘B’. The behaviour of the L1/L2 filtering may be configured by the network. Filtering reporting period at point ‘C’ equals one measurement period at point ‘B’. Point ‘C’ corresponds to a measurement after processing in the L1/L2 filter. The reporting rate is identical to the reporting rate at point ‘B’. This measurement is used as input for one or more evaluation of reporting criteria.

The Evaluation of reporting criteria block checks whether actual measurement reporting is necessary at point ‘D’. The evaluation may be based on more than one flow of measurements at reference point ‘C’ e.g., to compare between different measurements. This is illustrated by input points ‘C’ and ‘C’. The WTRU may evaluate the reporting criteria at least every time a new measurement result is reported at point ‘C’ and point ‘C1’. The reporting criteria are standardised, and the configuration may be provided by RRC signalling (WTRU measurements). Point ‘D’ corresponds to measurement report information (message) sent on the radio interface. For non-radio measurements, the network configuration may specify to filter them either as additional inputs at point ‘A’, or at point ‘B’. In a compatible design, the network configuration may specify inclusion of non-radio measurements as additional ‘C1’ inputs which will effectively bypass the filtering.

L1/L2 Beam filtering blocks correspond to a filtering performed on the measurements (i.e. beam specific measurements) provided at point ‘A1’. The behaviour of the L1/L2 beam filters may be part of the configuration. Filtering reporting period at point ‘E’ equals one measurement period at point ‘A1’. Point ‘E’ corresponds to a measurement (e.g., beam-specific measurement) after processing in the beam filter. The reporting rate is identical to the reporting rate at point ‘A1’. This measurement is used as input for selecting the X measurements to be reported.

The Beam Selection for beam reporting block selects the X measurements from the measurements provided at point ‘E’. The behaviour of the beam selection is standardised, and the configuration of this module may be provided by RRC signalling. Point ‘F’ correspond to beam measurement information included in measurement report (sent) on the radio interface.

LTM measurement configuration may provide the framework through which the network can configure LTM measurements comprising of radio and non-radio measurement quantities. The configured measurement quantities may be candidates for periodic, semi-persistent, aperiodic or event triggered reporting as indicated in “LTM Measurement Reporting Configuration”. The events once triggered can in turn trigger the reporting of event fulfillment and execution of relevant LTM switching to a target candidate cell/beam. These conditions, events, thresholds may be part of the “LTM Measurement Reporting Configuration”.

Although the configuration to lower layers may be primarily managed through RRC layer, the configured measurement quantities, radio, and non-radio measurement based, may be configured with conditions used to trigger certain LTM relevant events on PHY layer. In the PHY based evaluation, the PHY layer itself may perform the configured post-processing and filtering after making the measurements or getting the measurement quantities from other interfaces and local sensors.

A compatible design may to perform the condition evaluation to generate events and trigger certain procedures at the MAC layer. In this design, the PHY layer can be kept simple, and the measurements may be passed on to MAC layer at intervals according to the configuration. The post-processing and filtering may be configured to be performed at the PHY or MAC or partially at both layers. The MAC layer may evaluate the conditions on the processed quantities and may generate events. An additional advantage of this approach is that by disabling the MAC processing/filtering, the latency may be similar to PHY latency.

In a simpler approach, the configuration may just specify the filtering and post-processing to be performed with the periodicity specified/indicated. Then it may be WTRU implementation to implement this filtering and post-processing in any of its layers. In this case, the processing and time availability for the final quantities used to evaluate LTM triggers may become independent as to which layer/block they are implemented.

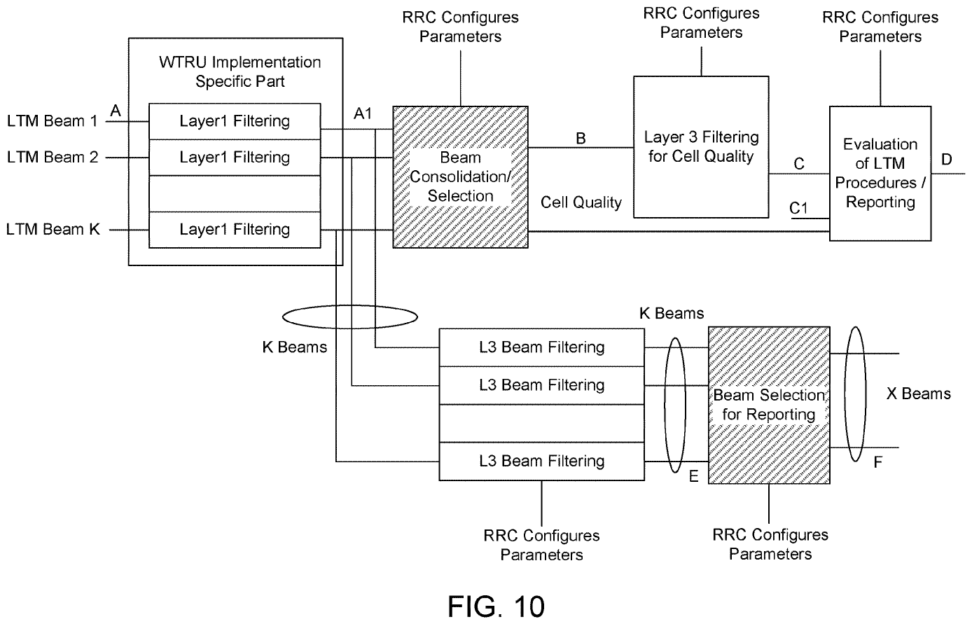

Referring to FIG. 10, in an embodiment, the LTM measurement framework may combine L1 and L3 filtered measurements and the LTM events may be set to be evaluated on these L1 or L3 or combination of these measurement quantities. The combining may be specified by the network and configured by the RRC layer. The LTM measurement model under L1/L3 measurements framework is shown in FIG. 10. FIG. 10 shows the inputs going from L1 beam consolidated measurements block going to the Evaluation of LTM procedures/reporting block (the think black solid line), which also received L3 filtered quantities from the Layer 3 filtering for cell quality block. For this measurement model, the event triggers and execution conditions may need to specify whether the quantities to be evaluated are L1 or L3.

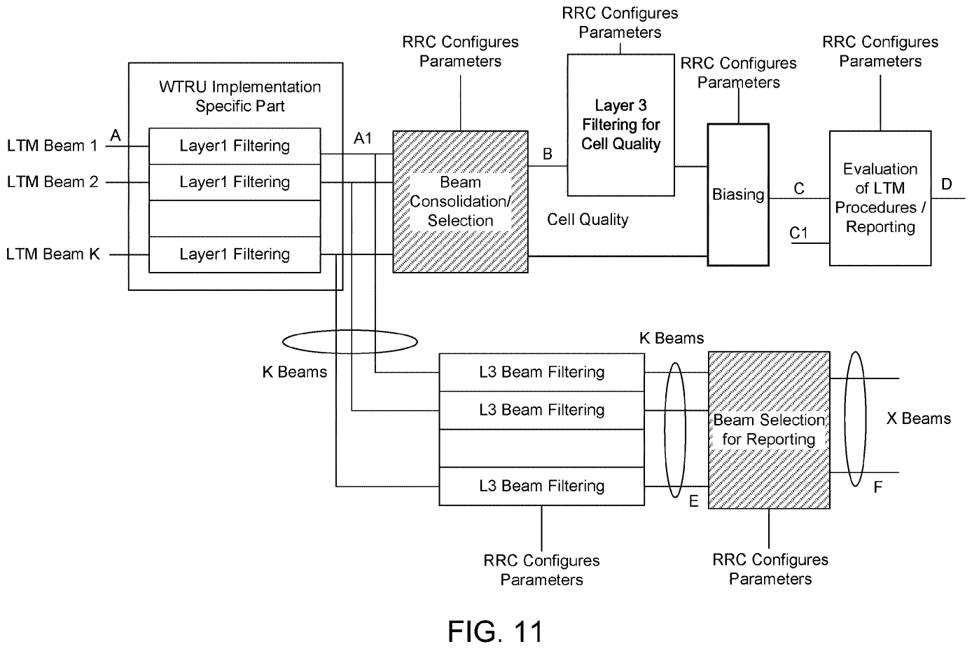

Referring to FIG. 11, in an embodiment, the L1 and L3 measurement quantities may be combined prior to evaluation of events. This is done in the biasing block. The biasing block may be configured with appropriate configuration parameters through which lower layer measurements can be biased with L3 filtered quantities. The biasing block may be configured to apply biasing to lower layer measurements based upon L3 filtered measurements according to the configuration parameters. The biasing block may be modeled as weighted combining of L1 and L3 measurements where the weights may be provided as part of the configuration. In another example, the biasing block may be considered as combining and filtering of input L1 and L3 quantities. In this way, the network may control a stable operating point for biased measurements which will then be used to evaluate the execution conditions prior to triggering the reporting and/or the LTM cell switching procedures.

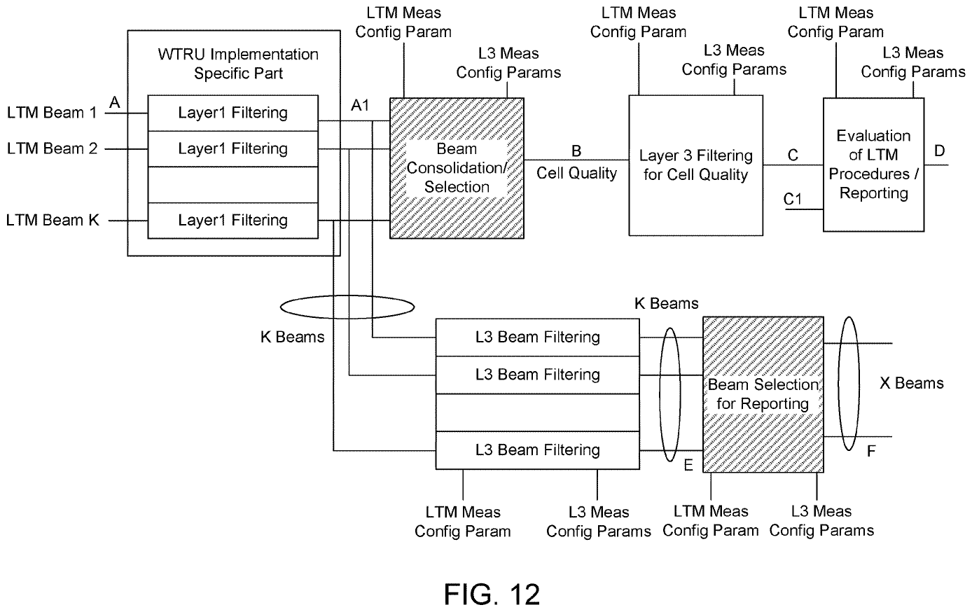

Referring to FIG. 12, in an embodiment, there could be a unified model for L3 and LTM measurements. Each of the blocks, e.g., beam consolidation/selection, L3 filtering for cells/beams quality, event evaluation parameters (offsets, hysteresis etc.) may be provided with two sets of configuration parameters. One set is used for L3 legacy measurements, and the second set is used for LTM relevant measurements processing and events evaluation/monitoring. It is to be noted that though not shown in this figure, the candidate quantities comprise all radio and non-radio measurements as discussed earlier.

For all the embodiments related to measurements processing, the network configuration may specify to filter the non-radio measurements. This can be achieved by adding non-radio measurements either as additional inputs at point ‘A’, or at point ‘B’. In a compatible design, the network configuration may specify inclusion of non-radio measurements as additional ‘C1’ inputs which will effectively bypass the filtering for these non-radio measurements.

For the various embodiments described herein, one of the (e.g., fundamental) themes may be the network sharing a piece of deployment/coverage information and the WTRUs configured with (e.g., suitable) LTM measurements comprising radio and non-radio quantities toward target cells/beam. The WTRUs will monitor and evaluate the configured quantities and upon triggering of certain events execute the LTM switch to target candidate cell/beam for which configured conditions get satisfied.

The reporting configuration may be expanded to include the new non-radio measurements-based events where WTRUs will use the data from local sensors. These events may use the deployment attributes of cells and beams, both serving (from primary cell group or secondary cell group), neighboring cells/beams, LTM configured candidate cells/beam as provided by the network configuration. This way, the events may be created based upon the non-data measurements. These events may be combined with the radio measurements-based events to validate the suitability of cells/beams for certain signal strength etc.

In an embodiment, composite events may be designed where conditions are specified for both non-radio measurement quantities (like location/position, orientation etc.) and radio measurement quantities (like RSRP/RSRQ/SINR related to SSB or CSI-RS or some other reference signals) and these composite events are triggered when the conditions from both radio and non-radio measurement groups are fulfilled. The triggering of these composite events may be used as trigger to execute certain WTRU procedures and actions. One aim of the various embodiments described herein may be to primarily use the events from LTM measurements (radio and non-radio based) to trigger LTM switching to target cell/beam.

For some of the LTM measurements, the configuration may provide the selection of the parameters related to additional post-processing or filtering coefficients which can be applied to the raw measurements. The post-processing or filtering may be configured for all LTM measurements, and thus (e.g., fully) applicable to radio and non-radio measurements. One of the objectives of this filtering or post-processing may be to do the additional processing to make these measurements quantities suitable for use in LTM procedures which may lead to intra-DU cell/beam switching, inter-DU cell/beam switching, inter-CU cell/beam switching. The proposed measurement framework may be used in other cell/beam level procedures.

In addition to the post-processing or filtering, LTM measurement framework may specify the derivation of cell level quantities from beam level measurements. The parameters and thresholds to determine the cell level quantities for reporting or event evaluation purpose (when configured) from beam level measured quantities may be specified as part of “LTM Measurement Quantity configuration”. The (e.g., suitable) “LTM Measurement Quantity configuration” may be indicated with its identity from “LTM Measurement Reporting Configuration”. In an embodiment, such mapping rules and relevant parameters may be provided directly as part of “LTM Measurement Reporting Configuration”.

The WTRUs configured with LTM measurements may monitor and evaluate events configured over (e.g., suitable) non-radio measurement quantities. The measurement quantities over which these event conditions are set may follow measurement models as explained above. Reference measurement models have been provided in above section where the event conditions may be set on the following: L1 measurement quantities alone; L3 measurement quantities alone; Joint events on L1 and L3 measurement quantities; L1 measurement quantities biased with L3 measurement quantities.

For non-radio measurement quantities, the filtering may be specified separately, or these quantities may be configured to undergo one of the above models. Then these non-radio measurements after processing/filtering may be fed to the event evaluation block.

The details on how these events may be used in specific procedures are explained in the various embodiments described herein. Some of the exemplary events on radio and non-radio measurements are described in the following sub-sections. The trigger conditions for the example events may use certain offsets and hysteresis values which may not always be desired for LTM measurements, as one point of this framework may be to react fast with changing channel conditions. To that aspect, either such additional tuning parameters, offsets and hysteresis may be removed altogether from the condition definitions, or they may be assigned zero or values to achieve the desired latency advantage.

In the below embodiments, some of the example LTM events defined which use the information from local sensors and/or non-3GPP interfaces are described. It would be important to mention that in some of these events, 3GPP Radio signals can be used to improve the quality of the measurement quantities. The prime examples of such events will be the events which use the location measurements where the network can aid to improve the estimation accuracy.

The proposed below embodiment tries to minimize the mobility interruptions through lower layer cell switching where the additional benefit and deterministic mobility aspects are gained by making use of information from non-3GPP radio signals. This category may combine non-3GPP radio signals and information data from local sensors, other interfaces etc. The events thus defined may become one important point of the proposed LTM procedures.

For LTM non-radio event LTM-V1, wherein WTRU velocity is becoming larger than a predetermined threshold, the WTRU may:
(1) consider the entering condition for this event to be satisfied when condition V1-1 is fulfilled, wherein condition V1-1 is: Mv−Hys>Thresh1 (entering condition 1)
(2) consider the leaving condition for this event to be satisfied when condition V1-2 is fulfilled, wherein condition V1-2 is: Mv+Hys<Thresh2 (Leaving condition 1) The variables in the formula are defined as follow: My is the WTRU velocity estimated by WTRU through its local sensors not taking into account any offsets. Mv may be expressed in Km/hour. Hys is the hysteresis parameter for this event (i.e. hysteresis as defined within configuration for this event). Hys is expressed in the same unit as Mv. Thresh1 is the threshold for this event defined as a reference velocity within configuration for this event and used as velocity threshold to enter this event. Thresh2 is the threshold for this event defined as a reference velocity within configuration for this event and used as velocity threshold to exit this event. Thresh1 and Thresh2 are expressed in the same unit as Mv.

For LTM non-radio event LTM-R1, wherein WTRU rotation occurring for an amount larger than a predetermined threshold, the WTRU may:
(1) consider the entering condition for this event to be satisfied when condition R1-1 is fulfilled, wherein condition R1-1 is: Mr−Hys >Thresh1 (entering condition 1)
(2) consider the leaving condition for this event to be satisfied when condition R1-2, is fulfilled; wherein condition R1-2 is: Mr+Hys >Thresh2 (Leaving condition 1)

The variables in the formula are defined as follows: Mr is the WTRU rotation estimated by WTRU through its local sensors not taking into account any offsets, where the rotation estimation is over a duration not exceeding a duration Td configured as part of the configuration. Mr may be expressed in degrees. In a compatible design, Mr may be expressed in radians. In a flexible approach, the unit for Mr may be configured as part of the configuration.

Hys is the hysteresis parameter for this event (i.e. hysteresis as defined within configuration for this event). Hys is expressed in the same unit as Mr. Thresh1 is the threshold for this event defined as an amount of reference rotation within configuration for this event and used as rotation threshold to enter this event. Thresh2 is the threshold for this event defined as an amount of reference rotation within configuration for this event and used as rotation threshold to exit this event. Thresh1 and Thresh2 are expressed in the same unit as Mr.

For LTM non-radio event LTM-O1, wherein WTRU Orientation changing from current orientation larger than a predetermined threshold, the WTRU may:
(1) consider the entering condition for this event to be satisfied when condition O1-1 is fulfilled, wherein condition O1-1 is: Mo−Hys>Thresh1 (Entering condition 1)
(2) consider the leaving condition for this event to be satisfied when condition O1-2 is fulfilled, wherein condition O1-2 is: Mo+Hys<Thresh2 (Leaving condition 1)

The variables in the formula are defined as follows: Mo is the change in WTRU orientation estimated by the WTRU through its local sensors not taking into account any offsets, where the orientation estimation may be over a duration not exceeding a duration Td configured as part of the configuration. Mo may be expressed in degrees. In a compatible design, Mo may be expressed in radians. In a flexible approach, the unit for Mo may be configured as part of the configuration. Hys is the hysteresis parameter for this event (e.g., hysteresis as defined within configuration for this event). Hys is expressed in the same unit as Mo. Thresh1 is the threshold for this event defined as an amount of reference orientation change within configuration for this event and used as threshold to enter this event. Thresh2 is the threshold same as Thresh1 and used as rotation threshold to exit this event. Thresh1 and Thresh2 are expressed in the same unit as Mo.

For LTM non-radio event LTM-OT1, wherein the WTRU Orientation is matching the direction of a given TRP/Cell within predetermined thresholds, the condition for this event may evaluate if the WTRU orientation is aligned towards a given TRP within a configured threshold. The WTRU self-orientation may be defined in a suitable manner e.g., the principal angle of its primary antenna (or antenna array) and may be obtained from local sensors. The WTRU orientation with respect to a reference TRP may be defined as the angle at the WTRU between its self-orientation and the line joining WTRU to the reference TRP. This determination may use a variety of sources and methods. In one method, the WTRU may use GPS signals processed at WTRU local sensor (hardware/firmware/software) combined with TRP location provided by the network. In another approach, the WTRU may process the TRP transmitted 3GPP radio signals and by local estimates made over these signals (such as angle of arrival etc.) to determine the angle of the reference TRP from the principal or broadside angle of its antenna array. This information may be used at the WTRU along with its self-orientation information to estimate the WTRU orientation with respect to the reference TRP.

In an embodiment, the current event LTM-OT1 may be configured such that the network provides a reference location to be used to evaluate WTRU orientation alignment with respect to the reference orientation. In this case, the network may ensure WTRU orientation alignment with respect to any reference orientation/direction which may have no link to any of its deployment topology. The WTRU may:
(1) consider the entering condition for this event to be satisfied when condition OT1-1 is fulfilled, wherein condition OT1-1 is: abs(Ou−Thresh1)<Hys1 (Entering condition), wherein the WTRU has an absolute orientation matching the cell beam
(2) consider the leaving condition for this event to be satisfied when condition OT1-2 is fulfilled, wherein condition OT1-2 is: abs(Ou−Thresh1)>Hys1 (Leaving condition)

The variables in the formula are defined as follows: Ou is the WTRU orientation estimated by the WTRU through its local sensors not taking into account any offsets. The reference for orientation estimation for this event can be the TRP location or a RS (e.g., beam) of the target cell/TRP. The use of TRP location or a signal from TRP as reference makes this orientation estimation alignment with respect to the given TRP. The reference TRP indication, location, signal to be used as reference from a given TRP are also provided as part of the network configuration. Ou may be expressed in degrees with respect to a configured measurement reference. In a compatible design, Ou may be expressed in radians. In a flexible approach, the unit for Ou may be configured as part of the configuration. Hys1 is the hysteresis parameter for orientation condition used for this event. Hys1 is expressed in the same unit as Ou. Thresh1 is the threshold for this event defined as an amount of reference orientation within configuration for this event and used as rotation threshold to enter this event. Thresh1 is expressed in the same unit as Ou.

For LTM non-radio event LTM-OD1, wherein the WTRU Orientation and Distance is matching the location of a given TRP/Cell-Coverage within predetermined thresholds, the WTRU may:
(1) consider the entering condition for this event to be satisfied when both condition OD1-1 and condition OD1-2, are fulfilled, wherein condition OD1-1 is abs(Ou−Thresh1)<Hys1 (entering condition 1), wherein the WTRU has absolute orientation matching the target Cell beam; and wherein condition OD1-2 is Ml+Hys2<Thresh2 (entering condition 2), wherein the WTRU is within a suitable distance from the target TRP.
(2) consider the leaving condition for this event to be satisfied when condition OD1-3 or condition OD1-4 is fulfilled, wherein condition OD1-3 is abs(Ou−Thresh1)>Hys1 (leaving condition 1); and wherein condition OD1-4 is Ml−Hys2>Thresh2 (leaving condition 2).

The variables in the formula are defined as follows: Ml is the WTRU location, represented by the distance between the WTRU and a reference location parameter for this event (e.g., reference location of candidate TRP for this event), not taking into account any offsets. MI may be expressed in meters. Ou is the WTRU orientation estimated by the WTRU through its local sensors not taking into account any offsets. The reference for orientation estimation for this event may be a RS (e.g., beam) of the target TRP. Ou may be expressed in degrees with respect to a configured measurement reference. In a compatible design, Ou may be expressed in radians. In a flexible approach, the unit for Ou may be configured as part of the configuration. Hys1 is the hysteresis parameter for orientation condition used for this event. Hys1 is expressed in the same unit as Ou. Hys2 is the hysteresis parameter for location condition used for this event. Hys2 is expressed in the same unit as Ml. Thresh1 is the threshold for this event defined as an amount of reference orientation within configuration for this event and used as rotation threshold to enter this event. Thresh1 is expressed in the same unit as Ou. Thresh2 is the threshold for this event defined as a distance from a reference location configured in configuration for this event. Thresh2 is expressed in the same unit as Ml.

For LTM non-radio event LTM-OD2, wherein the WTRU orientation and distance is matching better the location of a given TRP/Cell-Coverage than the serving TRP/Cell according to a configured Thresholds, the WTRU may:
(1) consider the entering condition for this event to be satisfied when both condition OD2-1 and condition OD2-2 are fulfilled, wherein condition OD2-1 is abs(Ou−On)−Hys1<abs(Ou−Op) (entering condition 1), wherein the WTRU has an absolute orientation aligning better the target cell TRP than the serving cell orientation; and wherein condition OD2-2 is Dn−Hys2<Dp (entering condition 2), wherein the WTRU is within a suitable distance from the target TRP.
(2) consider the leaving condition for this event to be satisfied when condition OD2-3 or condition OD2-4 is fulfilled, wherein condition OD2-3 is abs(Ou−On)+Hys1>abs(Ou−Op) (leaving condition 1); and wherein condition OD2-4 is Dn+Hys2>Dp (leaving condition 2).

The variables in the formula are defined as follows: Ou is the WTRU reference orientation in absolute units estimated by the WTRU through its local sensors not taking into account any offsets. Ou may be expressed in degrees with respect to a configured measurement reference. In a compatible design, Ou may be expressed in radians. In a flexible approach, the unit for Ou may be configured as part of the configuration. Op is the orientation of the serving TRP in absolute units from the WTRU as estimated by the WTRU using the location of the serving TRP received in configuration. On is the orientation of the neighbour TRP in absolute units from the WTRU as estimated by the WTRU using the location of the neighbour TRP received in configuration. Hys1 is the hysteresis parameter for orientation condition used for this event. Op, On and Hys1 are expressed in the same unit as Ou. Dn is the distance between the WTRU location and the location of the neighbour TRP where the location of the neighbour TRP is part of the configuration. Dn may be expressed in meters. Dp is the distance between the WTRU location and the location of the serving TRP where the location of the serving TRP is part of the configuration. Dp is expressed in the same unit as Dn. Hys2 is the hysteresis parameter for distance condition used for this event. Hys2 is expressed in the same unit as Dn.

For LTM non-radio event LTM-CM1, wherein the WTRU is crossing out the boundary of a specific zone in the coverage topology, the WTRU may:
(1) consider the entering condition for this event to be satisfied when condition CM1-1 is fulfilled, wherein condition CM1-1 is Ml1−Hys>Thresh1 (entering condition), wherein the WTRU crosses a boundary in the coverage topology.
(2) consider the leaving condition for this event to be satisfied when condition CM1-2 is fulfilled, wherein condition CM1-2 is Ml1+Hys<Thresh1 (leaving condition).

The variables in the formula are defined as follows: Ml1 is the WTRU location, represented by the distance between the WTRU and a reference location parameter for this event not taking into account any offsets. Ml1 may be expressed in meters. Hys is the hysteresis parameter for this event (e.g., hysteresis as defined within reportConfigNR for this event). Hys is expressed in the same unit as Ml1. Thresh1 is the threshold for this event defined as a distance from a reference location (e.g., serving TRP) to a boundary of the coverage topology. The WTRU may determine Thresh1 from the coverage topology using the information of its current location, the serving TRP location and the boundary definition according to the configuration. Boundary definition could correspond to the coverage of a RNA, TA, PLMN or even TRP coverage. Configuration may provide the information whether Thresh1 is a line of sight (LOS) distance (in that case, Thresh1 is the distance of the coverage boundary on the line joining the serving TRP and WTRU) or a different calculation is to be used. Thresh1 is expressed in the same unit as Ml1.

For LTM non-radio event LTM-CM2, wherein the WTRU is entering a specific zone, the event may evaluate the WTRU entering a specific zone. The zone identification may be provided to the WTRU through configuration. In an embodiment, the network may provide the coordinates for the zone center, its shape and the lengths delimiting the zone. The zone may be in the form of hexagon, square or a rectangle. The network may provide the center coordinates, one length parameter for square zones, two length parameters for rectangular zones, or more parameters for refined shaped zones. In an embodiment, the zone may represent sidelink style zones which may be obtained through a configured processing over the GPS coordinates. The network may provide to the WTRU the configuration to compute the zones. The WTRU may obtain its location/position estimate through local sensors. The WTRU location information may be aided by the radio or non-radio signals. The computed location may allow the WTRU to calculate its distance from the center of the zone and knowing the zone boundary. The WTRU may compute whether it has entered in a zone or not.

In an embodiment, the zones may be associated to the network deployment or coverage. In an embodiment, the network may specify the zone center as its deployed TRP. The zone boundaries may be provided through a choice of parameters which could be delimited in the square, rectangular or hexagon shapes by specifying associated parameters.

In an embodiment, the network may associate the configured zones to the effective coverage information of its cells, TRPs etc., that it may have acquired through past measurements reports from WTRUs, drive tests etc.

The WTRU may:
(1) consider the entering condition for this event to be satisfied when condition CM2-1 is fulfilled, wherein condition CM2-1 is Ml1−Hys<Thresh1 (entering condition), wherein the WTRU crosses into a specific zone in the coverage topology.
(2) consider the leaving condition for this event to be satisfied when condition CM2-2 is fulfilled, wherein condition CM2-2 is Ml1+Hys>Thresh1 (leaving condition).

The variables in the formula are defined as follows: Ml1 is the WTRU location, represented by the distance between the WTRU and a reference location parameter for this event not taking into account any offsets. The reference location is attributed to the specific zone to which this event is associated. Ml1 may be expressed in meters. Hys is the hysteresis parameter for this event (e.g., hysteresis as defined within reportConfigNR for this event). Hys is expressed in the same unit as Ml1. Thresh1 is the threshold for this event defined as a distance from a reference location (e.g., reference gNB/TRP location of the reference zone) to a boundary of the coverage topology. The WTRU may determine Thresh1 from the coverage topology using the information of its current location, the reference gNB/TRP location and the boundary definition according to the configuration. Boundary definition could correspond to the coverage of a RNA, TA, PLMN or even gNB/TRP coverage. Configuration may provide the information whether Thresh1 is LOS distance (in that case, Thresh1 is the distance of the coverage boundary on the line joining the reference TRP and WTRU) or a different calculation is to be used. The network may provide the value for Thresh1 matching the zone configuration. If zone configuration suffices, the network may expect the WTRU to determine the values for this threshold. Thresh1 is expressed in the same unit as Ml1.

For LTM non-radio event LTM-CM2V1 (LTM-CM2 && LTM-V1), wherein the WTRU is entering a specific zone in the coverage topology and velocity becoming larger than a predetermined threshold, LTM-CM2V1 may be used to conditionally trigger the WTRU reporting for LTM switching based upon non-radio measurements, in the form of location coordinates and velocity estimation. It may also be used to increase the measurement and reporting periodicity for some target neighbor candidate. This joint event may be set on location estimation (which may be obtained through non-radio measurements) and velocity estimation (primarily non-radio Measurements). In one configuration, this event may be specified solely over non-radio measurement quantities. Other configurations may exist where the location estimates may be obtained solely over radio measurements, or the measurement over 3GPP radio signals, or a combination of any or more the former sets.

The WTRU may:
(1) consider the entering condition for this event to be satisfied when condition CM2V1-1and condition CM2V1-2 are fulfilled, wherein condition CM2V1-1 is Ml−Hys1<Thresh1 (entering condition 1), wherein the WTRU crosses into a specific zone in the coverage topology; and wherein condition CM2V1-2 is Mv−Hys2>Thresh2 (entering condition 2)
(2) consider the leaving condition for this event to be satisfied when condition CM2V1-3or CM2V1-4 is fulfilled, wherein condition CM2V1-3 is Ml+Hys1>Thresh1 (leaving condition); and wherein condition CM2V1-4 is Mv+Hys2<Thresh2 (leaving condition)

The variables in the formula are defined as follows: Ml is the WTRU location, represented by the distance between the WTRU and a reference location parameter for this event not taking into account any offsets. The reference location may be attributed to the specific zone to which this event is associated. MI may be expressed in meters. Hys1 is the hysteresis parameter for this event (e.g., hysteresis as defined within reportConfigNR for this event) to be used in location conditions. Hys1 is expressed in the same unit as Ml1. Thresh1 is the threshold for this event defined as a distance from a reference location (e. g reference gNB/TRP location of the reference zone) to a boundary of the coverage topology. WTRU may determine Thresh1 from the coverage topology using the information of its current location, the reference gNB/TRP location and the boundary definition according to the configuration. Boundary definition could correspond to the coverage of a RNA, TA, PLMN or even gNB/TRP coverage. Configuration provides the information whether Thresh1 is LOS distance (in that case, Thresh1 is the distance of the coverage boundary on the line joining the reference TRP and WTRU) or a different calculation is to be used. Thresh1 is expressed in the same unit as Ml1. My is the WTRU velocity estimated by the WTRU through its local sensors not taking into account any offsets. Mv may be expressed in Km/hour. Hys2 is the hysteresis parameter for this event (e.g., hysteresis as defined within configuration for this event) to be used for velocity condition evaluation. Hys2 is expressed in the same unit as Mv. Thresh2 is the threshold for this event defined as a reference velocity within configuration for this event and used as velocity threshold to enter/exit this event. In another design, two separate thresholds may be configured for entry and exit conditions. Thresh2 is expressed in the same unit as Mv.

For LTM non-radio event LTM-CM2O1 (LTM-CM2 && LTM-OT1), wherein the WTRU is entering a specific zone in the coverage topology and orientation matching a configured orientation within a predetermined threshold, LTM-CM2O1 may be used to trigger WTRU reporting based upon non-radio measurements, in the form of location coordinates providing the zone entry information and orientation to a given TRP for a candidate configuration. It may also be used to increase the measurement and reporting periodicity for some target neighbor candidate.

This joint event may be set on location estimation (which may be obtained through Non-Radio Measurements) and orientation estimation (primarily non-Radio Measurements). Thus, in one configuration, this event may be specified solely over non-radio measurement quantities. Nevertheless, other configurations may exist where the location estimates are obtained solely over radio measurements, or the measurement over 3GPP radio signals, or a combination of any or more the former sets.

The WTRU may:
(1) consider the entering condition for this event to be satisfied when condition CM2O1-1 and condition CM2O1-2 are fulfilled, wherein condition CM2O1-1 is Ml−Hys1<Thresh1 (entering condition 1) wherein the WTRU crosses into a specific zone in the coverage topology; and wherein condition CM2O1-2 is abs(Mo−Hys2)<Thresh2 (entering condition 2)
(2) consider the leaving condition for this event to be satisfied when condition CM2O1-3 or CM2O1-4 is fulfilled, wherein condition CM2O1-3 is Ml+Hys1>Thresh1 (leaving condition), and wherein condition CM2O1-4 is abs(Mo+Hys2)>Thresh2 (leaving condition).

The variables in the formula are defined as follows: Ml is the WTRU location, represented by the distance between the WTRU and a reference location parameter for this event not taking into account any offsets. The reference location may be attributed to the specific zone to which this event is associated. Ml may be expressed in meters. Hys1 is the hysteresis parameter for this event (e.g., hysteresis as defined within reportConfigNR for this event) to be used in location conditions. Hys1 is expressed in the same unit as Ml. Thresh1 is the threshold for this event defined as a distance from a reference location (e.g., reference gNB/TRP location of the reference zone) to a boundary of the coverage topology. WTRU may determine Thresh1 from the coverage topology using the information of its current location, the reference gNB/TRP location and the boundary definition according to the configuration. Boundary definition could correspond to the coverage of a RNA, TA, PLMN or even gNB/TRP coverage. Configuration may provide the information whether Thresh1 is LOS distance (in that case, Thresh1 is the distance of the coverage boundary on the line joining the reference TRP and WTRU) or a different calculation is to be used. Thresh1 is expressed in the same unit as Ml. Mo is the WTRU orientation estimated by the WTRU through its local sensors not taking into account any offsets, where the orientation estimation is over a duration not exceeding a duration Td configured as part of the configuration. The reference for orientation estimation for this event may be one of the cardinal directions, a location (e.g., GPS coordinates) from WTRU antenna (e.g., a TRP location), a RS (e.g., beam) of the target TRP. Thus, orientation estimation may provide a measure how closely WTRU is aligned to a reference location/direction with respect to a reference WTRU antenna (or antenna panel). The reference location/direction and the reference WTRU antenna for orientation estimation are all parts of the configuration. Mo may be expressed in degrees. In a compatible design, Mo may be expressed in radians. In a flexible approach, the unit for Mo may be configured as part of the configuration. Hys2 is the hysteresis parameter for this event (i.e. hysteresis as defined within configuration for this event). Hys2 is expressed in the same unit as Mo. Thresh2 is the threshold for this event defined as an amount of reference orientation change within configuration for this event and used as threshold to enter this event. Thresh2 is expressed in the same unit as Mo.

The paragraphs above have provided some example events over non-radio measurement quantities which may be used to update the LTM related configurations, trigger reporting and trigger LTM switching decisions controlled by the network. These examples may be used to create additional events over non-radio measurement quantities which can identify the target scenario in a very precise manner and choose the most suitable candidate in intra-DU, inter-DU and/or inter-CU scenarios.

In an embodiment, the new events may be defined over a set of non-radio measurement quantities. This may bring advantages in cases where the environment is controlled, or the network may have gained thorough knowledge of the wireless environment in terms of terrain, buildings and other objects.

For devices with heavy rotational mobility, event LTM-R1 or event LTM-O1 may be combined with other non-radio measurement quantities to generate new events.

The examples provided above don't cover the events which can be created over the signals, measurements and identities related to WLAN, Bluetooth, other RATs or certain RF measurements. These could be defined where the network operator may have the knowledge of public deployment of such access points for other RATs or some reference locations with beacons transmissions or RF points. Then these measurements may be combined with other non-radio quantities to determine further refined events.

LTM mobility configurations and subsequent monitoring may require additional tracking at the WTRU for the cells/beams which may be potential targets for LTM mobility—whether in the activated or de-activated states. LTM mobility feature may require new WTRU capabilities in terms of receiving and maintaining LTM configurations, handling LTM switches to intra-DU and inter-DU candidates, and probably the most important monitor and report LTM measurements related to non-radio measurement quantities.

WTRU capabilities related to non-3GPP radio signals, local sensors and other interfaces may be used for non-radio measurements based LTM procedure. The WTRU may provide such capability to the network and based upon this knowledge, the network may determine a (e.g., suitable) set of non-radio measurement quantities as part of LTM measurements and configurations. Some of these non-radio measurement quantities may be used to trigger the events which will lead to reporting and subsequent cell switching. The other non-radio quantities may be part of the measurement report. The WTRU may provide the source of these non-3GPP RATs, or local sensors or other interfaces, and other relevant parameters such as availability, accuracy levels etc . . . to help network determining the (e.g., suitable) set of quantities to be used in non-radio measurements based LTM procedure.

The execution phase for the non-radio measurements based LTM procedure may (e.g., basically) comprise the WTRU monitoring and reporting based upon non-radio measurement quantities, network decision to switch the cell and issue the cell switch command, and the WTRU actions to perform the cell switching.

Once configured, the WTRU may start to monitor the configured measurement quantities. In some cases, there may be an activation phase either through timers or through explicit commands. LTM reporting configuration provides the necessary parameters to report the LTM measurements to the network. The measurement reports of interest for this disclosure may comprise non-radio measurement quantities configured by the network as part of configuration. The events becoming the basis of LTM cell switching procedure may be set/triggered over non-radio measurement quantities. Nevertheless, in case of reporting event getting triggered, the network may configure to provide a measurement report comprising of the radio measurement quantities and non-radio measurement quantities.

LTM reporting configuration may be configured such that LTM measurements may be reported as part of an uplink control information (UCI). In this design, LTM measurements are reported over PUCCH or PUSCH as specified in LTM reporting configuration with (e.g., suitable) parameters and periodicities.

LTM reporting configuration may be configured for some quantities such that LTM measurements may be reported as RRC messages. This design may be more suitable when latency is not an issue.

LTM reporting configuration may be provided as a hybrid reporting configuration. In a hybrid design, LTM measurements reporting may be configured partly as UCI transmitted over PUCCH/PUSCH (or used to trigger lower layer events) and partly reported over RRC messages. In an embodiment, LTM reporting may be configured such that the reporting takes place over RRC when certain conditions are fulfilled. If these conditions are not fulfilled, WTRU may start to report LTM measurements as part of UCI (PUCCH/PUSCH). The RRC configuration and UCI (PUCCH/PUSCH) configuration to report LTM measurements may be part of LTM reporting configuration. The LTM reporting configuration also provides the conditions which WTRU may use to select one specific reporting type and the conditions to switch to the other reporting type. These conditions can be specified in terms of when a WTRU is enjoying good channel conditions with its serving cell/beam. When the serving cell/beam quality is better than configured thresholds, the WTRU may be configured to report LTM measurements over RRC. The associated latency may not be an issue as the WTRU is under good channel conditions. When the channel conditions deteriorate, according to the conditions and thresholds provided as part of the configuration, the WTRU may switch to more agile lower layer reporting. In lower layer reporting, the periodicities may be shorter and resource overhead may be larger but that may be justified as the WTRU may be in risk of link degradation and these measurements may enable fast LTM switching to neighboring cells and beams.

For the network controlled LTM procedures, the network may take the decision when a given WTRU will switch from a serving cell, be it a serving cell or primary cell of any of its cell groups, to one of LTM target cell. The network may configure measurements to aid in its decision. In addition to WTRU measurements and feedback, the network may use other criteria and system level aspects to make the mobility decisions.

Once the network decides to move a WTRU from a serving cell to a target LTM cell, the network may provide the cell switch indication or command to the WTRU. The cell switch command may be provided to the WTRU along with necessary information enabling it to switch to the target cell. The cell switch command comprises of the LTM target configuration and the beam indication. The beam indication may be provided as the SSB index, CSI-RS index or a QCL identity, where this QCL is already configured by the network at the WTRU providing the reference signal against which this QCL is set. The beam indication can be an explicit or implicit indication. The cell switch command can also provide the indication about how to handle the data and control plane at the WTRU when performing the cell switch. This indication may be provided as explicit indication as if MAC/RLC entities need a reset and PDCP needs recovery etc ... In another compatible design, the network may only indicate whether the cell switch is intra-DU or inter-DU, and the WTRU may be programmed a-priori to perform the MAC/RLC/PDCP handling as per the inter-/intra-DU indication. In one example, MAC and RLC entities may be reset and PDCP can perform data recovery whenever inter-DU indication is transmitted by the network. And in case of intra-DU, no reset or data recovery may be initiated. The cell switch command can, in addition, indicate the type of signaling that the WTRU should use on the target cell while performing cell switching. As an example, the cell switching command may provide whether the WTRU should transmit RACH, or some specific PUCCH or some other signal on the target cell. In an embodiment, this information may be implicit as a function of other parameters of LTM target cell configuration. These may include if, for example, the target cell is already a serving cell or an activated cell etc. The cell switching command may also provide a timing advance in an explicit or implicit manner. As an example, if the deployment is for very small cells, the WTRU may need to apply no timing advance. This may be known from the configuration or indicated explicitly. In another example of no timing advance, the target cell may have the same timing as of the current serving cell, potentially within the margin of the cyclic prefix. In other cases, the network may (e.g., explicitly) indicate the timing advance value that the WTRU should apply while transmitting in the uplink direction to the target cell.

The network may transmit the cell switching command in a MAC-CE. MAC-CE based indication has the advantage that other relevant pieces of information required with cell switch command can be provided to the WTRU.

In an embodiment, the cell switch command may be provided over the PHY signaling. This may be achieved by designing a downlink control indication (DCI) with (e.g., special) fields capable of carrying LTM cell switch command parameters as described earlier. The PHY signaling can have lower latency and can reduce further the mobility interruptions.

In an embodiment (e.g., hybrid design), the network may keep both MAC and PHY based design. Thus, a WTRU is configured to receive LTM cell switching command through MAC and PHY signaling. Depending upon the situation, in terms of WTRU application requirements, WTRU report of non-radio measurement quantities, and the availability of transmission occasions, the network can determine MAC or PHY signaling to provide the LTM cell switch command to the WTRU in a timely manner.

When a WTRU performs LTM switching to an LTM target candidate, it applies the configuration of the LTM target candidate. Two primary use cases of LTM switching are when the LTM switching is happening to a target cell/beam candidate which is being served by the same DU or being served by a different DU. As a function of intra-DU or inter-DU LTM switching, a WTRU may need to handle the internal data plane entities, like MAC entity, RLC entity and PDCP in a different manner.

For intra-DU LTM switch, a WTRU may keep the MAC, RLC and PDCP entities unchanged.

For inter-DU LTM switch, a WTRU may reset its MAC and RLC entities and create new MAC and RLC entities according to the configuration of the target LTM candidate. For the PDCP, it may need to re-establish if RLC gets reset.

The determination of behavior to apply for MAC, RLC and PDCP layers reset may be left to WTRU to decide if it's an intra-DU or inter-DU LTM switching. The WTRU may determine the information of an LTM switch being intra-DU or inter-DU through the configuration of the serving cell and the candidate LTM configuration that it applies.

In an embodiment, each LTM configuration may provide indications whether MAC and/or RLC entities need to be reset or not, and if PDCP recovery is required.

For network controlled LTM switching, the LTM switching command may indicate the WTRU whether MAC and RLC entities need to be reset or not, and if PDCP recovery is required.

When a WTRU performs LTM switching to an LTM target candidate, it may need to transmit an indication to the LTM target candidate so that both the WTRU and the LTM target candidate have the same knowledge as to which cell/beam WTRU is performing LTM switching. The selection of UL indication may be part of LTM configuration.

For network controlled LTM switching, the LTM switching command may indicate the WTRU which type of UL indication to transmit at LTM switching event.

The design details for the uplink indication transmitted from the WTRU to the network upon LTM switching are described below.

In a physical random access channel (PRACH) transmission based indication embodiment, the WTRU may perform PRACH procedure to the LTM candidate cell/beam. Contention free random access channel (RACH) configuration may be provided for LTM candidates to speed up the RACH procedure.

In a RACH preamble based indication embodiment, the WTRU may perform the transmission of RACH preamble only. The preamble identity and the resources may be assigned for LTM candidate cell/beam. If the network has already provided the necessary cell configurations, the whole RACH procedure may not be necessary. In this case, transmitting only the RACH preamble to the LTM target candidate may save transmission resources and speed up the attach to the target candidate. This latency saving is very important as one objective of LTM may be to improve the latencies when cells/beam need to be switched in mobility procedures.

In a reference signal based indication embodiment, a WTRU may be configured to transmit some reference signals to the LTM target candidate cell/beam. These reference signals may be sounding reference signals (SRS). The configuration parameters for the SRS transmission including sequence, power, time-frequency resources may be provided to the WTRU as part of the LTM configuration. The source cell may have already communicated and coordinated such SRS transmission possibility and relevant parameters to the LTM target candidate which may be intra-DU or inter-DU switching. LTM target candidate may recognize the transmission of such SRS from the WTRU and may register that the WTRU has performed the LTM switch locally.

In PUCCH based indication embodiment, a WTRU may be configured with a PUCCH transmission to the LTM target candidate upon LTM switching to the target LTM candidate. The configuration of PUCCH transmission, including PUCCH format assignment, sequence assignment and PUCCH time-frequency resources etc . . . , is specific to the target LTM candidate. A configured PUCCH transmission may indicate to the LTM target that the WTRU has performed the LTM switch.

In an embodiment, a WTRU may be configured to transmit a scheduling request (SR) to the LTM target candidate over the configured PUCCH resources. The design may be kept simple by restricting it to short PUCCH, e.g., sequence based PUCCH format 0 transmission.

In an embodiment of non-Radio measurements based LTM procedure, the embodiment may use any of the following actions: (1) WTRU capability transfer for lower layer mobility / LTM handling and relevant assistance information, this step may be accompanied by the reporting of a set of non-radio measurements, the reporting may in addition be augmented with some radio measurements; (2) WTRU receiving LTM configurations along with (e.g., suitable) LTM non-radio measurement quantities and (e.g., suitable) events set over such non-radio measurements for reporting purpose; (3) WTRU performing configured Non-Radio Measurements; (4) WTRU detecting the change in non-radio and radio measurement quantities; (5) WTRU determining its zone through non-radio measurements; (6) Evaluation of the configured event with the conditions set over measurements of non-radio quantities; (7) Event based WTRU reporting of its configured non-radio measurement quantities such as zone, location/position and orientation, in case of event triggering. The network may configure the WTRU to report radio measurement quantities as part of the triggered measurement report. (8) WTRU receiving the network command to perform LTM mobility switch where the network may use the WTRU measurement reporting and other system level aspects to determine the target cell/beam configuration for the WTRU; (9) WTRU performing the LTM mobility switch as per the network command; (10) WTRU performing the protocol stack handling and transmitting UL indication as per the network configuration/indication.

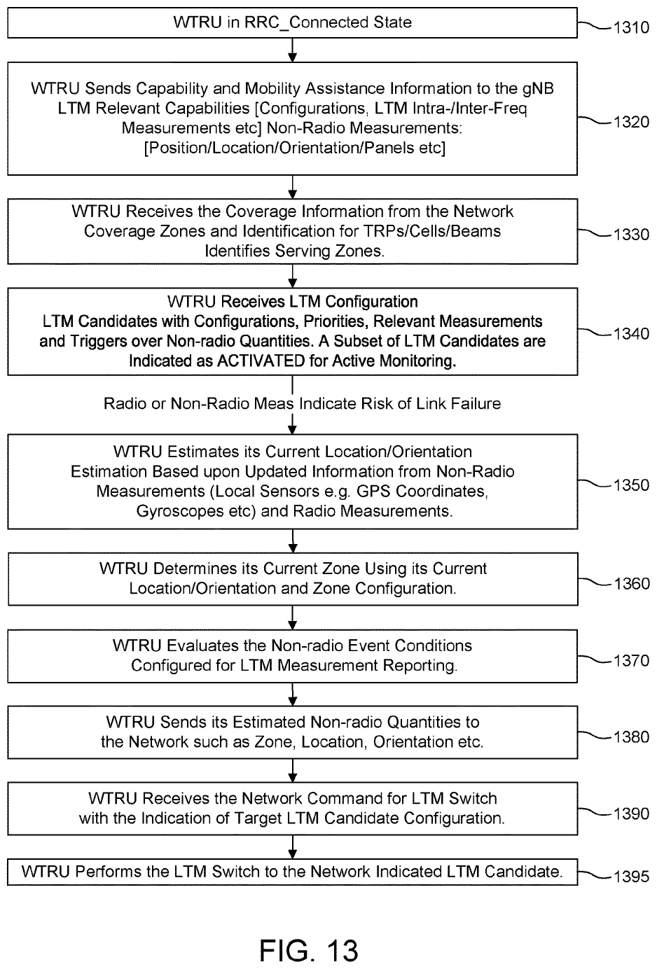

An example of a detailed network controlled mobility procedure triggered by WTRU non-radio measurements followed by the WTRU reporting is shown in Figure FIG. 13.

Referring to FIG. 13, the procedure may start at set 1310 wherein the WTRU is in RRC_CONNECTED state. At step 13320, the WTRU may provide to the network its capability to handle different aspects of lower layer mobility procedure. This capability may be grouped in formats covering different aspects of handling intra-DU, inter-DU configurations and mobility handling, maximum number of configurations a WTRU can be configured with. Of particular interest are the WTRU capabilities related to non-radio measurements (position, location, orientation, panels), relevant details, accuracy of such measurements etc .. which may help the network to determine LTM configurations. Along with LTM relevant capability in suitable format, the WTRU may also provide to the network (e.g., gNB) mobility assistance information. This information may comprise measurements and capability to perform various non-radio measurements. The set of measurements sent to the network which the network uses for preparation of mobility configurations may be the lower layer measurements, legacy L3 measurements, or a combination.

After receiving the capability and mobility assistance information, at step 1330, the WTRU may receive coverage information from the network. The coverage information may be a snapshot of the network deployment in proximity to the WTRU location. The coverage information may be provided to the WTRU by the network with (e.g., suitable) granularity according to the assistance information and the QoS/QoE requirements of the services that the WTRU is using or intends to use. In an embodiment, the WTRU may (e.g., only receive) from the network zone determination information without revealing any deployment information.

In addition to the coverage configuration, at step 1340, the WTRU may receive from the network (e.g., suitable) lower layer mobility configuration. Lower layer mobility configuration, or LTM configuration, may comprise of several candidate configurations. These configurations may be provided as serving cell configuration, cell group configuration or a bigger RRC reconfiguration message. In addition, these candidate configurations may be provided as individual configurations or as delta configuration against a (e.g., suitable) reference configuration. The reference configuration could be configured to be the configurations of the serving cell or provided as a standalone configuration. A subset of the LTM candidate configurations may be marked by the network in ACTIVATED or ENABLE state whereas others may be treated as DE-ACTIVATED. The WTRU will monitor the ACTIVATED candidates for potential LTM switching.

One important point is the network configuring the WTRU with non-radio measurement quantities as part of the LTM configuration step. The conditions set over such non-radio measurement quantities may trigger the WTRU measurement report sent to the network which becomes the basis for network deciding the LTM cell switching. After having received the LTM configurations, the WTRU may monitor the configured non-radio measurement quantities in periodic, semi-persistent, aperiodic or event triggered fashion as per the received configuration.

In case of the WTRU estimates degradation in the current serving link, where the degradation in link/beam quality is part of the configuration itself, at step 1350, the WTRU may estimate its current location, position and orientation. There may be additional non-radio measurements configured either through local sensors at the WTRU or information received through different interfaces. The link quality degradation detection may be configured over the beam based signals or cell based signals. The thresholds configured for the degradation determination may be different from the legacy beam failure detection or radio link failure detection as the objective here is to run the procedure prior to having a beam or link failure. As an alternative embodiment, the WTRU may receive from the network configuration information indicating monitoring non-radio measurement quantities in a periodic manner or whenever a change (beyond a certain threshold) is detected in these quantities.

After getting the updated estimates of its non-radio measurements in terms of location/position and orientation, at step 1360, the WTRU may determine its current zone according to the network provided coverage information. The parameters and constants to determine the zone information as a function of non-radio measurements of one or more of position, location and orientation may be part of coverage configuration.

After measuring the configured non-radio measurement quantities, at step 1370, the WTRU may evaluate the conditions set as the measurement reporting trigger. If the conditions get fulfilled, the WTRU may move to the next step 1380 of reporting of the configured measurement quantities.

At step 1380, the WTRU may transmit a report of configured non-radio measurements against the LTM measurement configuration for which event conditions get satisfied. If the reporting conditions for event based reporting are not satisfied, the WTRU may not send the corresponding event based report and keep on monitoring the quantities according to the configuration periodicities. The LTM measurement reporting may be periodic based. In this case, the WTRU may send the measurement report according to the periodicity or the timer expiry against which measurement report should be transmitted. In a compatible design not shown in this flowchart, the reporting may be aperiodic and could have been triggered by a mechanism such as RRC command or a PDCCH order by network transmitting a DCI to the WTRU.

Once the WTRU has determined the reporting needs to be done, tat step 1380, the WTRU may send the non-radio measurement quantities such its determined zone, position, location, orientation to the network as per the configured reporting configuration. The network may configure the WTRU to include some radio measurement quantities as part of the measurement report which got triggered over non-radio event.

The WTRU reporting of the non-radio measurements allows the network to select a LTM candidate among the prior configured LTM candidates in the ACTIVATED or enable state. Although not shown in this flowchart, the network may update the LTM configurations with updated measurement reports received from the WTRU. The network can also determine to not perform the LTM switching.

If the network switches the cell for the WTRU through LTM procedure, at step 1390, the WTRU may receive the network command to perform the LTM switch. The LTM switching command may comprise the indication of the target LTM candidate configuration. In addition to the target LTM candidate configuration, the network command of LTM switching may indicate the WTRU behavior for MAC/RLC reset and the type of UL indication WTRU may transmit subsequent to LTM switch event.

After having received the LTM candidate configuration to perform switching, at step 1395, the WTRU may perform the LTM switching to the target candidate. The switching may comprise of local handling of MAC and RLC entities at the WTRU. In an embodiment, the indication to perform the reset of MAC/RLC entities may be provided to the WTRU (e.g., explicitly) as part of the LTM configuration candidates and the WTRU may perform the reset of MAC and/or RLC entities as per the configuration of selected LTM candidate. In an embodiment, the WTRU may determine such information based upon whether the LTM target candidate involves intra-DU switching or inter-DU switching and by performing the pre-configured MAC/RLC reset actions for each of the intra-DU or inter-DU switching scenarios. In an embodiment, MAC/RLC reset handling may be indicated as part of LTM switching command.

The other part of the LTM switching may be related to providing the network an indication of LTM switch execution by the WTRU. Both the WTRU and the network may have the common view to communicate with each other after the LTM switching without any interruption. The WTRU may transmits an UL indication on the network provided LTM target candidate. This UL indication, relevant sequence selection and the selection of transmission resources where this indication is transmitted may be part of LTM configuration itself. In an embodiment, the WTRU may select the UL LTM switch indication as received in the network command to perform LTM switch.

It would be important to highlight that the conventional radio measurements may require some significant time for the purpose of estimation, filtering, reporting which may simply be unacceptable to achieve service continuity with mobility for dense deployment of narrow beam systems. Thus, the various embodiments of basing the lower layer mobility decisions on non-radio measurement quantities may provide a greater latency advantage which may simply not be achievable due to instability and latency issues with the radio measurements. The other benefits are in service continuity while in mobility and lower interruption times compared to legacy approaches.

In an embodiment, LTM procedure may be based upon events on location and orientation without network deployment information.

In such embodiment, the WTRU may provide the configuration of zone determination but is not provided the network deployment information. The WTRU may make use of its location and orientation information to trigger the lower layer reporting to the network configured as part of the lower layer triggered mobility procedures. The WTRU reporting may be through the network configuration over location and orientation measurements, triggers and thresholds. The reporting may let the network know the cell and beam for the WTRU for which it issues cell switch command to the WTRU.

This embodiment may use any of the following actions: WTRU capability transfer for lower layer mobility handling and relevant assistance information to support LTM procedure based upon non-radio measurement quantities. WTRU receiving the configuration to determine zone information and the orientation specific parameters and references. WTRU receiving LTM configurations along with (e.g., suitable) LTM non-radio measurement quantities and (e.g., suitable) events for reporting purpose set over a combination of non-radio measurements. In this embodiment, the network may configure the WTRU for events on zone entry (LTM-CM2) and potentially combined with velocity or orientation aligned to a certain location (LTM-OT1). The network may choose to the configure the joint event capturing these two aspects through a single event such as LTM-CM2O1. WTRU performing configured non-radio Measurements over its location and orientation according to the configured periodicity. WTRU detecting the change in non-radio or radio measurement quantities. WTRU determining its zone through non-radio measurements and zone configuration. WTRU evaluation of the configured event with the conditions set over location and orientation. Event based WTRU reporting of its zone, location/position and potentially radio measurement quantities according to the configuration, in case of event triggering for WTRU entering a specific zone and having orientation matching a given reference location according to the configuration. WTRU receiving the network command to perform LTM mobility switch where the network may use the WTRU reporting and other system level aspects to determine the target cell/beam configuration for the WTRU. WTRU performing the LTM mobility switch as per the network command. WTRU performing the protocol stack handling as per the network indication. WTRU transmitting UL indication as per the network configuration/indication where the network may indicate through LTM switching command or through prior configuration to transmit a reference signal (RS) or physical uplink control channel (PUCCH) based indication.

In an embodiment, LTM procedure may be based on Network Topology Information and based upon events on non-radio measurement quantities.

This embodiment may use any of the following actions: WTRU capability transfer for lower layer mobility/LTM handling and relevant assistance information to support LTM procedure based upon non-radio measurement quantities. WTRU receiving coverage and deployment topologies and the relevant configurations. WTRU receiving LTM configurations along with (e.g., suitable) LTM non-radio measurement quantities and (e.g., suitable) events for reporting purpose set over a combination of non-radio measurements making use of network provided deployment/coverage information.

In this embodiment, the network may indicate any of the proposed non-radio events as part of the configuration: non-radio events LTM-OD1, LTM-OD2 can be configured in scenarios with rotational and translational mobility with respect to some specific TRP (e.g., distributed unit) locations. Non-Radio events LTM-CM1, LTM-CM2, LTM-CM2V1 can be configured for potential switching evaluation when a WTRU may be entering a given zone. Non-Radio events LTM-CM2V1 can be configured for potential switching evaluation when a WTRU may be entering a given zone with high speed.

This embodiment may further use any of the following actions: WTRU performing configured non-radio measurements. WTRU detecting the change in non-radio or radio measurement quantities. WTRU determining its zone through non-radio measurements. WTRU evaluation of the configured event with the conditions set over measurements of non-radio quantities. Event based WTRU reporting of its zone, location/position and radio measurement quantities according to the configuration, in case of event triggering. WTRU receiving the network command to perform LTM mobility switch where the network may use the WTRU reporting and other system level aspects to determine the target cell/beam configuration for the WTRU. WTRU performing the LTM mobility switch as per the network command. WTRU performing the protocol stack handling as per the network indication embodiments. WTRU transmitting UL indication as per the network configuration/indication where the network may indicate through LTM switching command or through prior configuration to transmit an RS or PUCCH based indication.

In an embodiment, LTM procedure may be based on LTM measurements activation/de-activation associated to zones.

In this embodiment, the WTRU may be provided with the configuration of zone determination. The WTRU may make use of its location information to determine its zone according to the network configuration. As part of the LTM procedure, the network may configure the WTRU with LTM candidates. To reduce the measurement and tracking overhead, the LTM measurements may be mapped to relevant zones. These measurements thus may need to be activated, de-activated, performed and reported only upon WTRU determining itself in those zones. Thus, this may provide a lean mechanism for WTRU to trigger making measurements only in suitable zones and then provide reporting to the network according to the reporting and triggers in these measurements. The network can then use the relevant measurement reports to trigger (e.g., suitable) mobility procedures to target LTM candidates.

This embodiment may use any of the following actions: WTRU capability transfer for lower layer mobility/LTM handling and relevant assistance information to support LTM procedure based upon non-radio measurement quantities. WTRU receiving the configuration and parameters to determine zone information. WTRU receiving LTM Configurations for candidate cells. WTRU receiving LTM relevant measurement configurations (associated to LTM candidates) where the measurement configurations provide association to certain zones. The measurements can be part of measConfig in RRCreconfiguration, CSIconfiguration or through a new information element especially designed for LTM procedures. The association of measurement configuration to zone may be achieved through explicitly providing a set of zone identities where this measurement configuration gets activated, or this information can be provided in a different information element. WTRU performing configured non-radio Measurements for its location according to the configured periodicity. WTRU determining its location/zone through non-radio measurements. WTRU evaluating the conditions/events for the configured LTM measurements. WTRU monitors the active measurement configurations and provides report to the network as per the configuration therein. Upon change of WTRU zone, WTRU may activate the measurement configurations which are configured to be activated in the new zone. Upon change of WTRU zone, WTRU de-activates the measurement configurations which are not configured to be activated in the new zone.

The exemplary embodiment for L1L2 triggered mobility procedure may be described based upon FIG. 13. This procedure may start for a WTRU in RRC connected state. The WTRU may provide its capability information relevant for lower layer mobility/LTM handling and additional assistance information. This step may be accompanied by the reporting of a set of non-radio measurements. The capability and assistance information transfer can be triggered by the WTRU itself, for example if its measurements indicate some degradation in the coverage or if the WTRU is running or starting to run an application requiring low mobility interruptions. In another embodiment, the WTRU may be triggered by the network for sending the capability and assistance information, The network may trigger the WTRU by sending an (e.g., explicit) request to the WTRU. The network request may be sent as an RRC message as an example. After receiving the WTRU capability and assistance information, the network may provide the coverage and deployment topology to the WTRU (e.g., in suitable format). This information may be provided either as WTRU dedicated signaling or the system information broadcast signaling. In another design, the basic coverage information may be transmitted as system information broadcast and then refined in WTRU dedicated signaling for WTRU application requirements and its capability. The WTRU may receive from the network the LTM configurations along with (e.g., suitable) non-radio measurement quantities and (e.g., suitable) events for reporting purposes. The coverage information and the LTM configurations may be transmitted simultaneously or in any order by the network. The WTRU may start to measure and monitor the configured non-radio measurement quantities once the configuration has been completed by the network. In some cases, there may be an additional activation step for the measurement configurations upon which the WTRU may start to measure and monitor the configured quantities. The WTRU may be configured by the network to make periodic measurements over non-radio quantities or the WTRU may be configured to detect a change in its radio or non-radio measurement. In this case, the WTRU may move to the next step of making fresh measurements and evaluating the reporting conditions. The WTRU may estimate its non-radio measurement quantities which let it determine its zone from the network provided coverage topology configuration. For event based LTM measurement configurations, the WTRU may compute the measurement quantities according to the configured or standardized measurement model where the measurement quantities may be L1, L3, a combination or biased quantities. After estimating the configured non-radio measurement quantities, the WTRU may evaluate the conditions set as event trigger conditions for the measurement report. If the conditions get fulfilled resulting in triggering of the event in question, the WTRU may send a measurement report to the network. The WTRU may report the configured non-radio measurement quantities to the network which are configured as part of the measurement configuration. The report received from the WTRU provide information to the network such that the network may determine the (e.g., appropriate) next step. The WTRU may be changed by the network from its current serving cell to one of the configured and activated LTM cell configurations for which it gets the visibility from the WTRU measurement report. This decision may be a result of computation of the WTRU reported measurements combined with network level optimization considerations such as load balancing etc. In case of the network decides to change the WTRU serving cell to one of the LTM candidate cells, it may send the LTM cell switch command to the WTRU. Once the WTRU receives the network command to perform LTM mobility switch, the WTRU may perform the mobility switch to the network commanded target cell configuration.

A network command of LTM switching may comprise indication of the target LTM candidate configuration. In addition to the target LTM candidate configuration, the network command of LTM switching may indicate the WTRU behavior for MAC/RLC reset. The type of UL indication WTRU may transmit subsequent to LTM switch event.

After having received the LTM candidate configuration to perform LTM switching, the WTRU will perform the LTM switching to the target candidate. The LTM switching may comprise of local handling of MAC and RLC entities at the WTRU. In an embodiment, the indication to perform the reset of MAC/RLC entities may be provided to the WTRU (e.g., explicitly) as part of the LTM configuration candidates. The WTRU may perform a reset of MAC and/or RLC entities as per the configuration of selected LTM candidate. In another embodiment, the WTRU may determine such information based upon whether the LTM target candidate involves intra-DU switching or inter-DU switching and by performing the pre-configured MAC/RLC reset actions for each of the intra-DU or inter-DU switching scenarios. In yet another embodiment, MAC/RLC reset handling may be indicated as part of LTM switching command.

The other part of the LTM switching may be related to providing the network an indication of LTM switch execution by the WTRU. This is necessary so that both the WTRU and the network have the common view to communicate with each other after the LTM switching without any interruption. The WTRU may transmit an UL indication on the network provided LTM target candidate. This UL indication, relevant sequence selection and the selection of transmission resources where this indication is transmitted, may be part of LTM configuration itself. In an embodiment, the WTRU may select the UL LTM switch indication as received in the network command to perform LTM switch.

For LTM procedure embodiment based upon events on location and orientation without network deployment information, the WTRU is provided the configuration of zone determination but is not provided the network deployment information. The WTRU may make use of its location and orientation information to trigger the lower layer reporting to the network configured as part of the lower layer triggered mobility procedures. The WTRU reporting may be through the network configuration over location and orientation measurements, triggers and thresholds. The network may use the reporting to determine the cell and beam for the WTRU for which it issues cell switch command to the WTRU. This embodiment may comprise any of the following actions: WTRU capability transfer for lower layer mobility handling and relevant assistance information to support LTM procedure based upon non-radio measurement quantities; WTRU receiving the configuration to determine zone information and the orientation specific parameters and references (such as reference TRP selection); WTRU receiving LTM configurations along with (e.g., suitable) LTM non-radio measurement quantities and (e.g., suitable) events for reporting purpose set over a combination of non-radio measurements; WTRU performing configured non-radio measurements over its location and orientation according to the configured periodicity; WTRU detecting the change in non-radio or radio measurement quantities; WTRU determining its zone through non-radio measurements and zone configuration; WTRU evaluation of the configured event with the conditions set over location and orientation; event based WTRU reporting of its zone, location/position and potentially radio measurement quantities according to the configuration, in case of event triggering for WTRU entering a specific zone and having orientation matching a given reference location according to the configuration; WTRU receiving the network command to perform LTM mobility switch where the network may use the WTRU reporting and other system level aspects to determine the target cell/beam configuration for the WTRU; WTRU performing the LTM mobility switch as per the network command; WTRU performing the protocol stack handling as per the network indication in dynamic signaling or part of the LTM configuration; and WTRU transmitting UL indication as per the network configuration/indication where the network may indicate through LTM switching command or through prior configuration to transmit an RS or PUCCH based indication.

For the action wherein the WTRU is receiving LTM configurations along with (e.g., suitable) LTM non-radio measurement quantities, the network may configure the WTRU for events on zone entry (LTM-CM2) and potentially combined with velocity or orientation aligned to a certain location (LTM-OT1). In addition, the network may choose to the configure the joint event capturing these two aspects through a single event such as LTM-CM2O1.

For LTM procedure embodiments using network topology information and based upon events on non-radio measurement quantities, this embodiment may comprise any of the following actions: WTRU capability transfer for lower layer mobility/LTM handling and relevant assistance information to support LTM procedure based upon non-radio measurement quantities; WTRU receiving coverage and deployment topologies and the relevant configurations; WTRU receiving LTM Configurations along with (e.g., suitable) LTM non-radio measurement quantities and (e.g., suitable) events for reporting purpose set over a combination of non-radio measurements making use of network provided deployment/coverage information; WTRU performing configured non-Radio measurements; WTRU detecting the change in non-radio or radio measurement quantities; WTRU determining its zone through non-radio measurements; WTRU evaluation of the configured event with the conditions set over measurements of non-radio quantities; event based WTRU reporting of its zone, location/position and radio measurement quantities according to the configuration, in case of event triggering; WTRU receiving the network command to perform LTM mobility switch where the network may use the WTRU reporting and other system level aspects to determine the target cell/beam configuration for the WTRU; WTRU performing the LTM mobility switch as per the network command; WTRU performing the protocol stack handling as per the network indication; and WTRU transmitting UL indication as per the network configuration/indication where the network may indicate through LTM switching command or through prior configuration to transmit an RS or PUCCH based indication.

For the action wherein the WTRU is receiving LTM configurations along with (e.g., suitable) LTM non-radio measurement quantities and (e.g., suitable) events for reporting purpose set, the network may indicate any of the following non-radio events as part of the configuration: non-radio events LTM-OD1, LTM-OD2 may be configured in scenarios with rotational and translational mobility with respect to some specific TRP (DU) locations; non-radio events LTM-CM1, LTM-CM2, LTM-CM2V1 may be configured for potential switching evaluation when a WTRU may be entering a given zone; and non-radio events LTM-CM2V1 may be configured for potential switching evaluation when a WTRU is entering a given zone with high speed.

For an embodiment wherein the LTM measurements activation/de-activation are associated to zones, the WTRU is provided the configuration of zone determination. The WTRU may make use of its location information to determine its zone according to the network configuration. As part of the LTM procedure, the WTRU may be configured by the network with LTM candidates. To reduce the measurement and tracking overhead, the LTM measurements may be mapped to (e.g., relevant zones). These measurements may need to be activated, de-activated, performed and reported (e.g., only) upon WTRU determining itself in those zones. Thus, this provides a lean mechanism for WTRU to trigger making measurements (e.g., only) in (e.g., suitable) zones and then provide reporting to the network according to the reporting and triggers in these measurements. The network may use the relevant measurement reports to trigger mobility procedures to target LTM candidates. This embodiment may comprise any of the following actions: WTRU capability transfer for lower layer mobility/LTM handling and relevant assistance information to support LTM procedure based upon non-radio measurement quantities; WTRU receiving the configuration and (e.g., suitable) parameters to determine zone information; WTRU receiving LTM Configurations for candidate cells; WTRU receiving LTM relevant measurement configurations (associated to LTM candidates) where the measurement configurations provide association to certain zones; WTRU performing configured Non-Radio Measurements for its location according to the configured periodicity; WTRU determining its location/zone through non-radio measurements; WTRU evaluating the conditions/events for the configured LTM measurements; upon change of WTRU zone, the WTRU may activate the measurement configurations which are configured to be activated in the new zone, and the WTRU may de-activates the measurement configurations which are not configured to be activated in the new zone; and WTRU monitoring the active measurement configurations and provides report to the network as per the configuration therein.

For the action wherein the WTRU is receiving LTM relevant measurement configurations where the measurement configurations provide association to certain zones, the measurements may be part of measConfig in RRCreconfiguration, CSIconfiguration or through a new information element especially designed for LTM procedures. The association of measurement configuration to zone may be achieved through (e.g., explicitly) providing a set of zone identities where this measurement configuration gets activated, or this information may be provided in a different information element.

For an embodiment wherein LTM procedure are based upon periodic reporting of non-radio measurement quantities. This embodiment may comprise any of the following key actions: WTRU capability transfer for lower layer mobility/LTM handling and relevant assistance information to support LTM procedure based upon non-radio measurement quantities; receiving coverage and deployment topologies and the relevant configurations; WTRU receiving LTM configurations along with (e.g., suitable) LTM non-radio measurement quantities and periodic reporting configuration; WTRU performing configured non-radio measurements; WTRU determining its zone through non-radio measurements; upon timer expiry, WTRU reporting the configured non-radio measurement quantities such as its zone, location/position and radio measurement quantities according to the configuration; upon receiving the WTRU measurement report, the network may compare the measurement quantities with the thresholds and previous measurements; the network may determine one of the activated LTM configurations based upon WTRU report and other system level considerations; WTRU receiving the network command to perform LTM mobility switch where the network may use the WTRU reporting of non-radio measurement quantities and other system level aspects to determine the target cell/beam configuration for the WTRU; WTRU performing the LTM mobility switch as per the network command; WTRU performing the protocol stack handling as per the network indication; and WTRU transmitting UL indication as per the network configuration/indication where the network may indicate through LTM switching command or through prior configuration to transmit an RS or PUCCH based indication.

For an embodiment wherein the activation of LTM candidate configurations is based upon WTRU reported zone information, the network may control activation and de-activation of (e.g., suitable) LTM candidate configurations. As part of the configuration, the network may provide the parameters relevant to determine the WTRU zone information. The network may also provide the necessary measurements information which allows WTRU to determine its zone information. The zone information can be determined from location information which WTRU can obtain from local GNSS measurements. This can be done through the local GNSS receiver. The location information can be determined through other non-radio measurements. The WTRU may have (e.g., a-priori) informed the network about its capabilities in making non-3GPP radio and non-radio measurements.

The WTRU may receive from the network LTM candidate configurations. These candidate configurations may comprise cell configuration, and the events and conditions over non-radio measurements which the WTRU may evaluate triggering the WTRU reporting.

The WTRU may be configured by the network to periodically estimate its location through configured measurements. Based upon these periodic estimates, the WTRU may determine its zone information as per the coverage topology configuration. The WTRU may be configured to report the zone information to the network. The reporting may be configured with periodicity according to the WTRU mobility and the QoS requirements. To reduce the reporting overhead, the WTRU reporting may be event based and (e.g., only) reported in case the WTRU estimated zone changes from the previous zone. The WTRU zone information may be transmitted to the network as part of the UCI. A new MAC-CE may be designed to provide zone information. Upon receiving the updated zone information, the network may update the ACTIVATED LTM configurations. The network may send an “LTM config activation” MAC-CE which can activate the LTM configurations. Two different MAC-CEs may be designed to accommodate a different number of LTM configurations which may need to be activated for an eventual LTM procedure. Customized MAC-CEs may be designed for this purpose where the identities of the LTM configurations may provide pointers to the LTM configurations configured through RRC signaling. One design for activation MAC-CE may be bitmap based where the network may indicate the activation status for each configured LTM configuration. For more reactive situations, a PHY based signaling such as DCI can be used to activate one of the configured LTM configurations.

Thus, this embodiment has a significant advantage in terms of resource overhead and latency reduction. The WTRU may monitor (e.g., closely) the configured measurements only for the LTM configurations corresponding to its positions which are activated by the network. This may save the WTRU from making unnecessary measurements over the candidate configurations which are not necessary for its updated location.

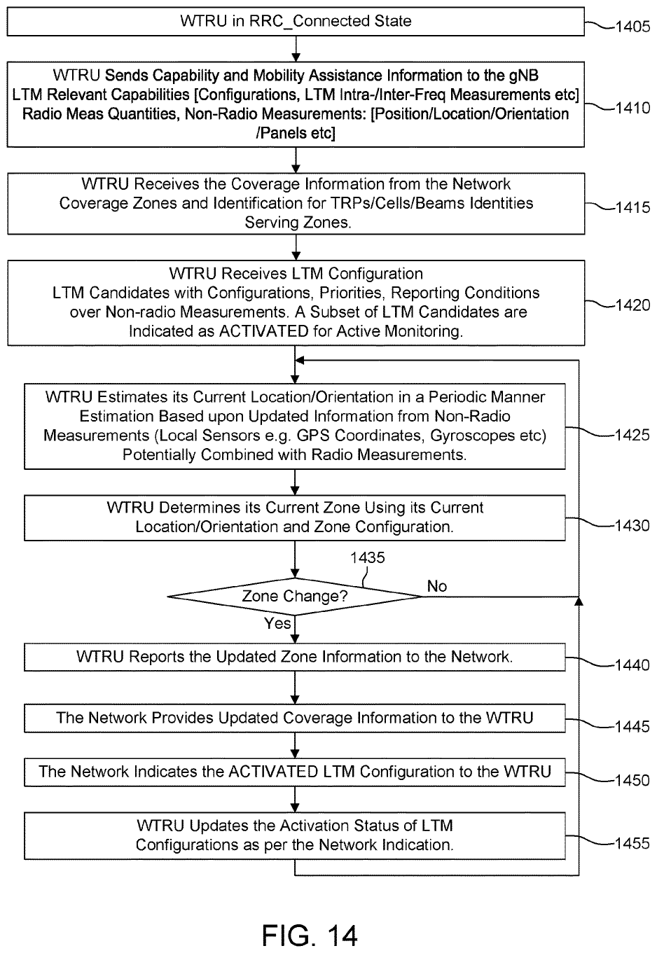

This embodiment is illustrated through the flow chart diagram of FIG. 14.

Referring to FIG. 14, the procedure may start at set 1405 wherein the WTRU is in RRC_CONNECTED state. At step 1410, WTRU capability may be sent to a gNB/cell/base station for lower layer mobility/LTM handling and relevant assistance information to support LTM procedure based upon non-radio measurement quantities. At step 1415, the WTRU may receive coverage and deployment topologies and the relevant configurations to determine the zone information. At step 1420, the WTRU may receive LTM configurations along with (e.g., suitable) LTM non-radio measurement quantities and (e.g., suitable) non-radio events for reporting purpose. A subset of LTM configurations may be indicated as ACTIVATED by the network as part of the configuration/initialization. At step 1425, the WTRU may be configured to determine/estimate periodically its zone information based upon non-radio measurements for aiding in configuration activation/de-activation. At step 1430, in order to determine its zone through the non-radio measurements, the WTRU may perform configured measurements associated to the ACTIVATED LTM configurations and may perform configured non-radio measurements for activation/de-activation purpose configured to determine its zone information.

At step 1435, the WTRU may determine if newly determined zone is different from the previous zone. If it is the case, then the WTRU may perform the four following steps.

At step 1440, the WTRU may transmit a report the network though UL indicating its newly determined zone information.

At step 1445, the WTRU may receive from the network, updated coverage information (e.g., an update of coverage topology).

At step 1450, the WTRU may receive from the network, an updated list of activated and de-activated LTM configuration. The network may add or remove candidates in the list of configured LTM candidates.

At step 1455, the WTRU may update the activation status of the list of configured LTM candidates, updating the status as per the network indication.

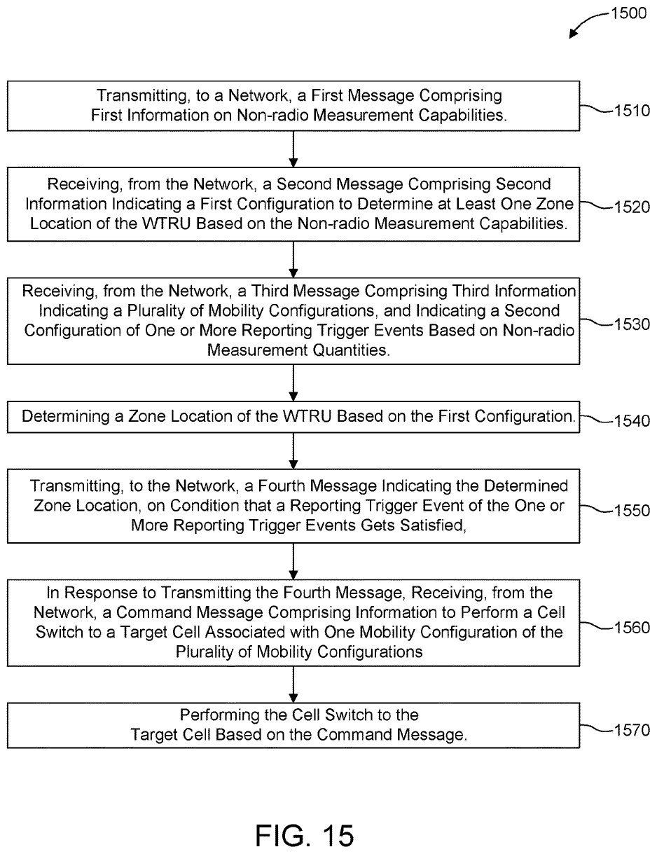

Referring to FIG. 15, a method 1500, implemented in a wireless transmit/receive unit, WTRU, for performing cell switch based on WTRU zone location, according to an embodiment is shown. The method 1500 may comprise a step wherein the WTRU may transmit 1510, to a network, a first message comprising first information on non-radio measurement capabilities. The method 1500, may comprise a step wherein the WTRU may receive 1520, from the network, a second message comprising second information indicating a first configuration to determine zone location of the WTRU based on the non-radio measurement capabilities. The method 1500 may comprise a step wherein the WTRU may receive 1530, from the network, a third message comprising third information indicating a plurality of mobility configurations, and indicating a second configuration of reporting trigger events based on non-radio measurement quantities. The plurality of mobility configurations may be a plurality of lower layer triggered mobility (LTM), configurations. The method 1500, may comprise a step wherein the WTRU may determine 1540 WTRU zone location based on the first configuration to determined zone location. The method 1500 may comprise a step wherein, on condition that a reporting trigger event of the configured reporting trigger events gets satisfied, the WTRU may transmit 1550, to the network, a fourth message indicating the determined zone location. The method 1500, wherein, in response to transmitting the fourth message, the WTRU may receive 1560, from the network, a command message comprising information to perform a cell switch to a target cell associated with one mobility configuration of the plurality of mobility configurations. The cell switch may be a LTM mobility cell switch. The method 1500 may comprise a step wherein the WTRU may perform 1570 the cell switch to the target cell based on the command message.

The non-radio measurements may comprise at least one measurement based upon data from local sensors. Local sensors may be any of motion sensors, environmental sensors, position sensors and velocity measurement sensors.

The plurality of mobility configurations may comprise respectively information indicating zone locations to activate or de-activate mobility configuration. The fourth message may further indicate an activated mobility configuration of the plurality of mobility configurations, based on the determined zone location.

The method 1500 may comprise a step wherein the WTRU may perform the non-radio measurements based on the non-radio measurement capabilities; and wherein the WTRU may determine the non-radio measurements quantities based on the performed non-radio measurements. Performing the non-radio measurements over WTRU location may be according to a configured periodicity. The configured reporting trigger events may comprise a change of the determined WTRU zone location from a previously determined WTRU zone location.

The method 1500, may comprise a step wherein the WTRU may perform a protocol stack handling based on the one mobility configuration associated with the target cell. Alternatively, the method 1500 may comprise a step wherein the WTRU may perform a protocol stack handling based on network indication on a dynamic signaling.

The method 1500 may comprise a step wherein the WTRU may transmit, to the network, an uplink, UL message, comprising indication of the performing of the cell switch.

The method 1500 may comprise a step wherein the second information further indicates a third configuration to determine WTRU orientation based on non-radio measurement capabilities, and wherein the WTRU may determine WTRU orientation based on the third configuration, and wherein the fourth message further indicates the determined WTRU orientation. The reporting trigger conditions may comprise any of (i) change of the determined WTRU zone location from a previously determined WTRU zone location, and (ii) change of orientation of the WTRU beyond a configured threshold.

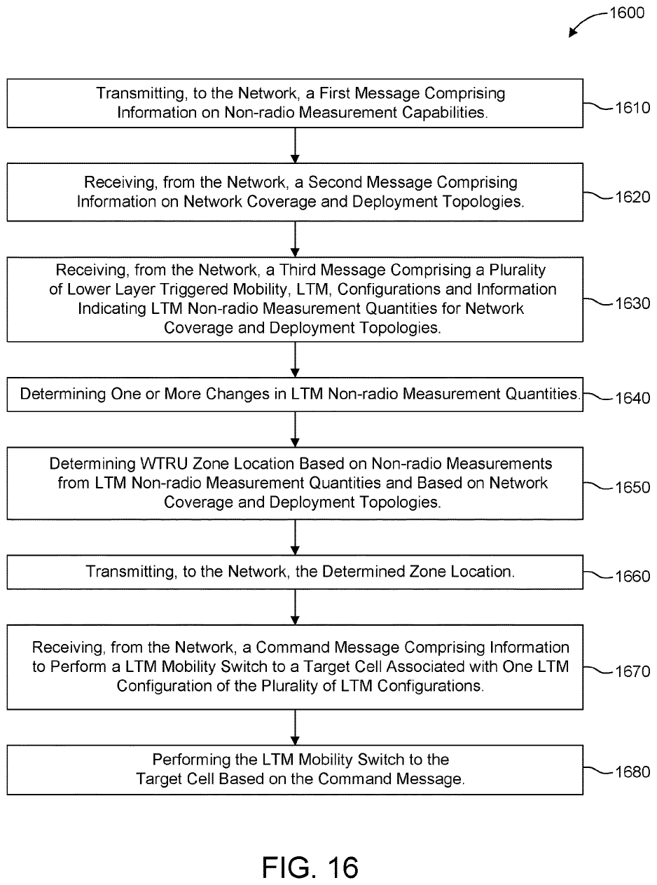

Referring to FIG. 16, a method 1600, implemented in a wireless transmit/receive unit, WTRU, for performing cell switch based on WTRU zone location, according to another embodiment.

The method 1600, may comprise a step wherein the WTRU may transmit 1610, to the network, a first message comprising information on non-radio measurement capabilities. The method 1600 may comprise a step wherein the WTRU may receive 1620, from the network, a second message comprising information on network coverage and deployment topologies. The method 1600, may comprise a step wherein the WTRU may receive 1630, from the network, a third message comprising a plurality of mobility configurations and information indicating (e.G., LTM) non-radio measurement quantities for network coverage and deployment topologies. The plurality of mobility configurations may be a plurality of lower layer triggered mobility (LTM), configurations. The method 1600 may comprise a step wherein the WTRU may determine 1640 one or more changes in (e.g., LTM) non-radio measurement quantities. The method 1600 may comprise a step wherein the WTRU may determine 1650 WTRU zone location based on non-radio measurements from the non-radio measurement quantities and based on network coverage and deployment topologies. The method 1600 may comprise a step wherein the WTRU may transmit 1660, to the network, the determined zone location. The method 1600 may comprise a step wherein the WTRU may receive 1670, from the network, a command message comprising information to perform a cell switch to a target cell associated with one configuration of the plurality of configurations. The cell switch may be a LTM mobility cell switch. The method 1600 may comprise a step wherein the WTRU may perform 1680 the cell switch to the target cell based on the command message.

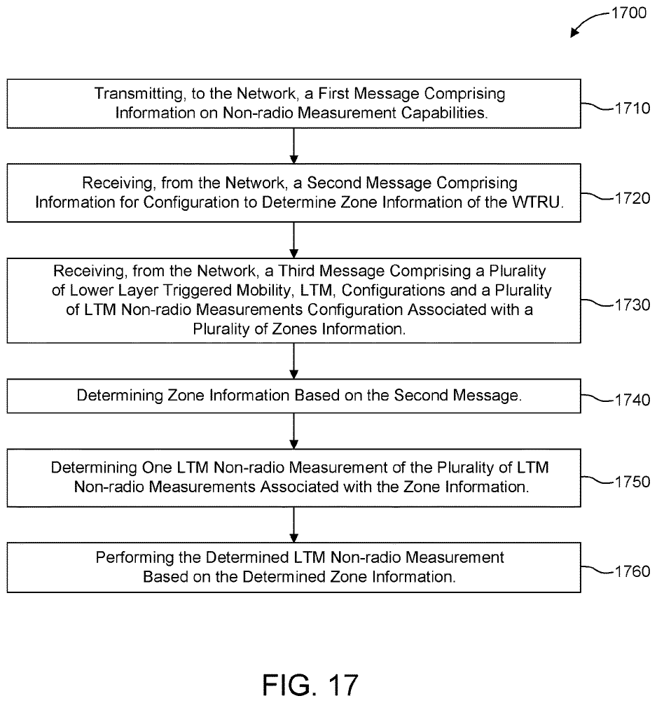

Referring to FIG. 17, a method 1700, implemented in a WTRU, for performing non-radio measurements based on WTRU zone information according to an embodiment, is shown.

The method 1700 may comprise a step wherein the WTRU may transmit 1710, to the network, a first message comprising information on non-radio measurement capabilities. The method 1700 may comprise a step wherein the WTRU may receive 1720, from the network, a second message comprising information for configuration to determine zone information of the WTRU. The method 1700 may comprise a step wherein the WTRU may receive 1730, from the network, a third message comprising a plurality of mobility configurations and a plurality of (e.g., LTM) non-radio measurements configuration associated with a plurality of zone information. The plurality of mobility configurations may be a plurality of lower layer triggered mobility (LTM) configurations. The method 1700 may comprise a step wherein the WTRU may determine 1740 zone information based on the second message. The method 1700 may comprise a step wherein the WTRU may determine 1750 one non-radio measurement of the plurality of non-radio measurements associated with the zone information. The method 1700 may comprise a step wherein the WTRU may perform 1760 the determined (e.g., LTM) non-radio measurement based on the determined zone information. Each of the plurality of zones information may comprises a zone identifier and wherein each zone identifier may be associated with an information indicating activation of (e.g., LTM) non-radio measurement or de-activation of (e.g., LTM) non-radio measurement.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, 16 or means-plus-function claim format, and any claim without the terms “means for” is not so intended.

1. A method, implemented in a wireless transmit/receive unit; (WTRU), the method comprising:
transmitting, to a network, a first message comprising first information on non-radio measurement capabilities;
receiving, from the network, a second message comprising second information indicating a first configuration to determine at least one zone location of the WTRU based on the non-radio measurement capabilities;
receiving, from the network, a third message comprising third information indicating a plurality of mobility configurations, and indicating a second configuration of one or more reporting trigger events based on non-radio measurement quantities;
determining the at least one zone location of the WTRU based on the first configuration;
on condition that a reporting trigger event of the one or more reporting trigger events is satisfied, transmitting, to the network, a fourth message indicating the determined at least one zone location;
in response to transmitting the fourth message, receiving, from the network, a command message comprising information to perform a cell switch to a target cell, wherein the target cell is associated with one mobility configuration of the plurality of mobility configurations; and
performing the cell switch to the target cell based on the command message.

2. The method of claim 1, wherein the plurality of mobility configurations comprises a plurality of lower layer triggered mobility (LTM) configurations, and wherein the cell switch is an LTM mobility cell switch.

3. The method of claim 1, comprising:
performing non-radio measurements based on the non-radio measurement capabilities; and
determining the non-radio measurement quantities based on the performed non-radio measurements.

4. The method of claim 32 comprising performing the non-radio measurements over a location of the WTRU according to a configured periodicity.

5. The method of claim 1, wherein the configured reporting trigger events comprise a change of the determined at least one zone location from a first-previously determined at least one zone location.

6-7. (canceled)

8. The method of claim 1, comprising transmitting, to the network, an uplink (UL) message comprising an indication of the performing of the cell switch.

9. The method of claim 1, wherein the non-radio measurements comprise at least one measurement based upon data from local sensors.

10. (canceled)

11. The method of claim 1, wherein the second information further indicates a third configuration to determine a WTRU orientation based on non-radio measurement capabilities, the method further comprising:
determining the WTRU orientation based on the third configuration; and
wherein the fourth message further indicates the determined WTRU orientation.

12. The method of claim 11, wherein the reporting trigger events comprise any of (i) change of the determined at least one zone location from a second previously determined at least one zone location, and (ii) change of orientation of the WTRU beyond a configured threshold.

13. The method of claim 1, wherein the plurality of mobility configurations comprises respectively information indicating zone locations to activate or de-activate a respective mobility configuration of the plurality of mobility configurations.

14. The method of claim 13, wherein the fourth message further indicates an activated mobility configuration of the plurality of mobility configurations, based on the determined at least one zone location.

15. A wireless transmit/receive unit (WTRU), comprising a memory and a processor, configured to:
transmit, to a network, a first message comprising first information on non-radio measurement capabilities;
receive, from the network, a second message comprising second information indicating a first configuration to determine at least one zone location of the WTRU based on the non-radio measurement capabilities;
receive, from the network, a third message comprising third information indicating a plurality of mobility configurations, and indicating a second configuration of one or more reporting trigger events based on non-radio measurement quantities;
determine the at least one zone location of the WTRU based on the first configuration;
transmit, to the network, a fourth message indicating the determined at least one zone location, on condition that a reporting trigger event of the one or more reporting trigger events is satisfied;
receive, from the network, a command message comprising information to perform a cell switch to a target cell, wherein the target cell is associated with one mobility configuration of the plurality of mobility configurations, in response to transmitting the fourth message; and
perform the cell switch to the target cell based on the command message.

16. The WTRU of claim 15, wherein the plurality of mobility configurations comprises a plurality of lower layer triggered mobility (LTM) configurations, and wherein the cell switch is an LTM mobility cell switch.

17. The WTRU of claim 15, configured to:
perform non-radio measurements based on the non-radio measurement capabilities; and
determine the non-radio measurement quantities based on the performed non-radio measurements.

18. (canceled)

19. The WTRU of claim 15, wherein the configured reporting trigger events comprise a change of the determined at least one zone location from a first previously determined at least one zone location.

20-21. (canceled)

22. The WTRU of claim 15, configured to transmit, to the network, an uplink (UL) message comprising indication of the performing of the cell switch.

23. The WTRU of claim 15, wherein the non-radio measurements comprise at least one measurement based upon data from local sensors.

24. (canceled)

25. The WTRU of claim 15, wherein the second information further indicates a third configuration to determine a WTRU orientation based on non-radio measurement capabilities, the WTRU being configured to:
determine the WTRU orientation based on the third configuration; and
wherein the fourth message further indicates the determined WTRU orientation.

26. The WTRU of claim 25, wherein the reporting trigger events comprise any of (i) change of the determined at least one zone location from a second previously determined at least one zone location, and (ii) change of orientation of the WTRU beyond a configured threshold.

27. The WTRU of claim 15, wherein the plurality of mobility configurations comprises respectively information indicating zone locations to activate or de-activate a respective mobility configuration of the plurality of mobility configurations.

28-34. (canceled)
